(19) United States
(12) Patent Application Publication
(10) Pub. No.: US 2026/0247480 A1
(43) Pub. Date: Aug. 20, 2026

(54) EXTENDED ACTIVE PERIOD OF CELLULAR DISCONTINUOUS TRANSMISSION AND DISCONTINUOUS RECEPTION

(71) Applicant: QUALCOMM Incorporated, San Diego, CA (US)

(72) Inventors: Hung Dinh LY, San Diego, CA (US); Kexin XIAO, Shanghai (CN)

(21) Appl. No.: 19/472,524

(22) PCT Filed: May 12, 2023
(86) PCT No.: PCT/CN2023/093751

§ 371 Date: Oct. 3, 2025

(51) Int. Cl. H04W 76/28; H04W 8/22; H04W 56/00; H04W 74/0816

(52) U.S. Cl. CPC H04W 76/28; H04W 8/22; H04W 56/0015; H04W 74/0816

(57) ABSTRACT

Methods, systems, and devices for wireless communications are described. A user equipment (UE) may receive a first indication that a network entity is operating in a discontinuous operation mode, which may be a discontinuous transmission (DTX) mode, a discontinuous reception (DRX) mode, or both, which includes both active and inactive periods. The UE may then receive a second indication that a set of symbols or slots is allocated for synchronization signal block (SSB) reception or random access transmission, where the set of symbols or slots at least partially overlaps with the inactive period. The UE may then extend the active period to overlap the set of symbols or slots based on Active Period Non-active Period Active Period at least one of the set of symbols or slots being within a thresh-of Cell DTX/DRX of Cell DTX/DRX of Cell DTX/DRX old quantity of symbols or slots from the active period, and may communicate via SSB reception or random access transmission during the extended active period.

### CROSS REFERENCE

The present Application is a 371 national phase filing of International PCT Application No. PCT/CN2023/093751 by LY et al., entitled “EXTENDED ACTIVE PERIOD OF CELLULAR DISCONTINUOUS TRANSMISSION AND DISCONTINUOUS RECEPTION,” filed May 12, 2023, which is assigned to the assignee hereof, and which is expressly incorporated by reference in its entirety herein.

### FIELD OF TECHNOLOGY

The following relates to wireless communications, including extended active period of cellular discontinuous transmission (DTX) and discontinuous reception (DRX).

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support extended active period of cellular discontinuous transmission (DTX) and discontinuous reception (DRX). For example, the described techniques provide for efficiently handling periodic signaling that is scheduled for an inactive period of DRX or DTX. In such cases, a network entity or a user equipment (UE) may determine whether to “extend” an active period of DTX or DRX operation in order to transmit or receive synchronization signal blocks (SSBs) or to transmit or monitor for random access channel (RACH) transmissions. For example, a UE may receive a first indication that the network entity in communication with the UE is operating in a discontinuous operation mode (e.g., a DTX mode, a DRX mode, or both), which includes both active and inactive periods. The UE may then receive a second indication (e.g., via system information) that a set of slots or symbols are allocated for periodic signaling such as SSB reception or for RACH transmission, where the set of slots or symbols at least partially overlap with the inactive period. The UE may then extend the active period to overlap the set of slots or symbols based on at least one of the set of slots or symbols being within a threshold quantity of slots or symbols from the active period. The UE may then communicate with the network entity during the extended active period through the SSB reception or the RACH transmission.

A method for wireless communications at a UE is described. The method may include receiving a first indication that a network entity in communication with the UE is operating in a discontinuous operation mode, where the discontinuous operation mode is a cell-based DTX mode, a cell-based DRX mode, or both, and where the discontinuous operation mode includes an active period and an inactive period that are both within a periodicity, receiving a second indication that a set of symbols or slots is allocated for SSB reception at the UE for the cell-based DTX mode or for random access transmission at the UE for the cell-based DRX mode, where the set of symbols or slots at least partially overlap with the inactive period of the discontinuous operation mode, extending the active period of the discontinuous operation mode to overlap the set of symbols or slots based on at least one of the set of symbols or slots being within a threshold quantity of symbols or slots from the active period prior to extension, and participating in communications with the network entity during the extended active period through the SSB reception or the random access transmission.

An apparatus for wireless communications at a UE is described. The apparatus may include a processor, memory coupled with the processor, and instructions stored in the memory. The instructions may be executable by the processor to cause the apparatus to receive a first indication that a network entity in communication with the UE is operating in a discontinuous operation mode, where the discontinuous operation mode is a cell-based DTX mode, a cell-based DRX mode, or both, and where the discontinuous operation mode includes an active period and an inactive period that are both within a periodicity, receive a second indication that a set of symbols or slots is allocated for SSB reception at the UE for the cell-based DTX mode or for random access transmission at the UE for the cell-based DRX mode, where the set of symbols or slots at least partially overlap with the inactive period of the discontinuous operation mode, extend the active period of the discontinuous operation mode to overlap the set of symbols or slots based on at least one of the set of symbols or slots being within a threshold quantity of symbols or slots from the active period prior to extension, and participate in communications with the network entity during the extended active period through the SSB reception or the random access transmission.

Another apparatus for wireless communications at a UE is described. The apparatus may include means for receiving a first indication that a network entity in communication with the UE is operating in a discontinuous operation mode, where the discontinuous operation mode is a cell-based DTX mode, a cell-based DRX mode, or both, and where the discontinuous operation mode includes an active period and an inactive period that are both within a periodicity, means for receiving a second indication that a set of symbols or slots is allocated for SSB reception at the UE for the cell-based DTX mode or for random access transmission at the UE for the cell-based DRX mode, where the set of symbols or slots at least partially overlap with the inactive period of the discontinuous operation mode, means for extending the active period of the discontinuous operation mode to overlap the set of symbols or slots based on at least one of the set of symbols or slots being within a threshold quantity of symbols or slots from the active period prior to extension, and means for participating in communications with the network entity during the extended active period through the SSB reception or the random access transmission.

A non-transitory computer-readable medium storing code for wireless communications at a UE is described. The code may include instructions executable by a processor to receive a first indication that a network entity in communication with the UE is operating in a discontinuous operation mode, where the discontinuous operation mode is a cell-based DTX mode, a cell-based DRX mode, or both, and where the discontinuous operation mode includes an active period and an inactive period that are both within a periodicity, receive a second indication that a set of symbols or slots is allocated for SSB reception at the UE for the cell-based DTX mode or for random access transmission at the UE for the cell-based DRX mode, where the set of symbols or slots at least partially overlap with the inactive period of the discontinuous operation mode, extend the active period of the discontinuous operation mode to overlap the set of symbols or slots based on at least one of the set of symbols or slots being within a threshold quantity of symbols or slots from the active period prior to extension, and participate in communications with the network entity during the extended active period through the SSB reception or the random access transmission.

In some examples of the method, apparatuses, and non-transitory computer-readable medium described herein, the threshold quantity of symbols or slots may be a negative value so that extension of the active period may be based on the set of symbols or slots partially overlapping with the active period prior to extension.

In some examples of the method, apparatuses, and non-transitory computer-readable medium described herein, the threshold quantity of symbols or slots may be negative one.

Some examples of the method, apparatuses, and non-transitory computer-readable medium described herein may further include operations, features, means, or instructions for extending the active period of the discontinuous operation mode may be further based on the set of symbols or slots being located before a start of the active period prior to extension.

Some examples of the method, apparatuses, and non-transitory computer-readable medium described herein may further include operations, features, means, or instructions for extending the active period of the discontinuous operation mode may be further based on the set of symbols or slots being located after an end of the active period prior to extension.

In some examples of the method, apparatuses, and non-transitory computer-readable medium described herein, the threshold quantity of symbols or slots may be a positive value so that extension of the active period may be based on an edge slot or an edge symbol of the set of symbols or slots being less than the threshold quantity of symbols or slots from a boundary of the active period prior to extension.

In some examples of the method, apparatuses, and non-transitory computer-readable medium described herein, the edge slot or the edge symbol may be a last symbol or slot of the set of symbols or slots, and the boundary may be a beginning of the active period prior to extension.

In some examples of the method, apparatuses, and non-transitory computer-readable medium described herein, extending the active period of the discontinuous operation may include operations, features, means, or instructions for shifting the beginning of the active period to begin at a first symbol or slot of the set of symbols or slots.

In some examples of the method, apparatuses, and non-transitory computer-readable medium described herein, the edge symbol or edge slot may be a first symbol or a first slot of the set of symbols or slots, and the boundary may be an ending of the active period prior to extension.

In some examples of the method, apparatuses, and non-transitory computer-readable medium described herein, extending the active period of the discontinuous operation mode may include operations, features, means, or instructions for shifting the ending of the active period to end at a last symbol or a last symbol or slot of the set of symbols or slots.

In some examples of the method, apparatuses, and non-transitory computer-readable medium described herein, the threshold quantity of symbols or slots includes a fixed value, may be received via radio resource control signaling, may be based on a capability of the UE, or combinations thereof.

In some examples of the method, apparatuses, and non-transitory computer-readable medium described herein, the threshold quantity of symbols or slots may be a first value when extension of the active period includes a shifting of a beginning of the active period and a second value when extension of the active period includes a shifting of an ending of the active period, and the first value and the second value may be a same value.

In some examples of the method, apparatuses, and non-transitory computer-readable medium described herein, the threshold quantity of symbols or slots may be a first value when extension of the active period includes a shifting of a beginning of the active period and a second value when extension of the active period includes a shifting of an ending of the active period, and the first value and the second value may be different values.

Some examples of the method, apparatuses, and non-transitory computer-readable medium described herein may further include operations, features, means, or instructions for receive the second indication in a system information block, where the second indication indicates one or more locations for the SSB reception or the random access transmission at the UE.

In some examples of the method, apparatuses, and non-transitory computer-readable medium described herein, the second indication further indicates the one or more locations as being associated with a set of transmitted SSBs from a set of SSBs in a SSB transmission occasion.

Some examples of the method, apparatuses, and non-transitory computer-readable medium described herein may further include operations, features, means, or instructions for determining the one or more locations for the SSB reception based on a total number of SSBs that may be scheduled to be transmitted in a SSB transmission occasion.

Some examples of the method, apparatuses, and non-transitory computer-readable medium described herein may further include operations, features, means, or instructions for transmitting a capability indication message indicating a capability of the UE to support extension of the active period for the SSB reception or for the random access transmission at the UE.

In some examples of the method, apparatuses, and non-transitory computer-readable medium described herein, the set of symbols or slots may be allocated for both the SSB reception and for the random access transmission at the UE and the method, apparatuses, and non-transitory computer-readable medium may include further operations, features, means, or instructions for determining to extend the active period of the discontinuous operation mode based on one of the SSB reception or the random access transmission.

In some examples of the method, apparatuses, and non-transitory computer-readable medium described herein, the set of symbols or slots may be allocated for both the SSB reception and for the random access transmission at the UE and the method, apparatuses, and non-transitory computer-readable medium may include further operations, features, means, or instructions for determining to extend the active period of the discontinuous operation mode based on both the SSB reception and the random access transmission.

In some examples of the method, apparatuses, and non-transitory computer-readable medium described herein, the second indication includes one or more separate configurations or a joint configuration for the SSB reception and for the random access transmission at the UE.

A method for wireless communications at a network entity is described. The method may include operating in a discontinuous operation mode, where the discontinuous operation mode is a cell-based DTX mode, a cell-based DRX mode, or both, and where the discontinuous operation mode includes an active period and an inactive period that are both within a periodicity, allocating a set of symbols or slots for SSB transmission at the network entity for the cell-based DTX mode or for random access reception at the network entity for the cell-based DRX mode, where the set of symbols or slots at least partially overlaps with the inactive period of the discontinuous operation mode, extending the active period of the discontinuous operation mode to overlap the set of symbols or slots based on at least one of the set of symbols or slots being within a threshold quantity of symbols or slots from the active period prior to extension, and participating in communications with a UE during the extended active period through the SSB transmission or the random access reception.

An apparatus for wireless communications at a network entity is described. The apparatus may include a processor, memory coupled with the processor, and instructions stored in the memory. The instructions may be executable by the processor to cause the apparatus to operate in a discontinuous operation mode, where the discontinuous operation mode is a cell-based DTX mode, a cell-based DRX mode, or both, and where the discontinuous operation mode includes an active period and an inactive period that are both within a periodicity, allocate a set of symbols or slots for SSB transmission at the network entity for the cell-based DTX mode or for random access reception at the network entity for the cell-based DRX mode, where the set of symbols or slots at least partially overlaps with the inactive period of the discontinuous operation mode, extend the active period of the discontinuous operation mode to overlap the set of symbols or slots based on at least one of the set of symbols or slots being within a threshold quantity of symbols or slots from the active period prior to extension, and participate in communications with a UE during the extended active period through the SSB transmission or the random access reception.

Another apparatus for wireless communications at a network entity is described. The apparatus may include means for operating in a discontinuous operation mode, where the discontinuous operation mode is a cell-based DTX mode, a cell-based DRX mode, or both, and where the discontinuous operation mode includes an active period and an inactive period that are both within a periodicity, means for allocating a set of symbols or slots for SSB transmission at the network entity for the cell-based DTX mode or for random access reception at the network entity for the cell-based DRX mode, where the set of symbols or slots at least partially overlaps with the inactive period of the discontinuous operation mode, means for extending the active period of the discontinuous operation mode to overlap the set of symbols or slots based on at least one of the set of symbols or slots being within a threshold quantity of symbols or slots from the active period prior to extension, and means for participating in communications with a UE during the extended active period through the SSB transmission or the random access reception.

A non-transitory computer-readable medium storing code for wireless communications at a network entity is described. The code may include instructions executable by a processor to operate in a discontinuous operation mode, where the discontinuous operation mode is a cell-based DTX mode, a cell-based DRX mode, or both, and where the discontinuous operation mode includes an active period and an inactive period that are both within a periodicity, allocate a set of symbols or slots for SSB transmission at the network entity for the cell-based DTX mode or for random access reception at the network entity for the cell-based DRX mode, where the set of symbols or slots at least partially overlaps with the inactive period of the discontinuous operation mode, extend the active period of the discontinuous operation mode to overlap the set of symbols or slots based on at least one of the set of symbols or slots being within a threshold quantity of symbols or slots from the active period prior to extension, and participate in communications with a UE during the extended active period through the SSB transmission or the random access reception.

In some examples of the method, apparatuses, and non-transitory computer-readable medium described herein, the threshold quantity of symbols or slots may be a negative value so that extension of the active period may be based on the set of symbols or slots partially overlapping with the active period prior to extension.

In some examples of the method, apparatuses, and non-transitory computer-readable medium described herein, the threshold quantity of symbols or slots may be negative one.

Some examples of the method, apparatuses, and non-transitory computer-readable medium described herein may further include operations, features, means, or instructions for extending the active period of the discontinuous operation mode may be further based on the set of symbols or slots being located before a start of the active period or before an end of the active period prior to extension.

Some examples of the method, apparatuses, and non-transitory computer-readable medium described herein may further include operations, features, means, or instructions for extending the active period of the discontinuous operation mode may be further based on the set of symbols or slots being located after an end of the active period prior to extension.

In some examples of the method, apparatuses, and non-transitory computer-readable medium described herein, the threshold quantity of symbols or slots may be a positive value so that extension of the active period may be based on an edge symbol or slot of the set of symbols or slots being less than the threshold quantity of slots from a boundary of the active period prior to extension.

In some examples of the method, apparatuses, and non-transitory computer-readable medium described herein, the edge symbol or slot may be a last symbol or slot of the set of symbols or slots, and the boundary may be a beginning of the active period prior to extension.

In some examples of the method, apparatuses, and non-transitory computer-readable medium described herein, extending the active period of the discontinuous operation may include operations, features, means, or instructions for shifting the beginning of the active period to begin at a first symbol or slot of the set of symbols or slots.

In some examples of the method, apparatuses, and non-transitory computer-readable medium described herein, the edge symbol or slot may be a first symbol or slot of the set of symbols or slots, and the boundary may be an ending of the active period prior to extension.

In some examples of the method, apparatuses, and non-transitory computer-readable medium described herein, extending the active period of the discontinuous operation mode may include operations, features, means, or instructions for shifting the ending of the active period to end at a last symbol or slot of the set of symbols or slots.

In some examples of the method, apparatuses, and non-transitory computer-readable medium described herein, the threshold quantity of symbol or slots includes a fixed value, may be transmitted via radio resource control signaling, may be based on a capability of the UE, or combinations thereof.

In some examples of the method, apparatuses, and non-transitory computer-readable medium described herein, the threshold quantity of symbols or slots may be a first value when extension of the active period includes a shifting of a beginning of the active period and a second value when extension of the active period includes a shifting of an ending of the active period and the first value and the second value may be a same value.

In some examples of the method, apparatuses, and non-transitory computer-readable medium described herein, the threshold quantity of symbols or slots may be a first value when extension of the active period includes a shifting of a beginning of the active period and a second value when extension of the active period includes a shifting of an ending of the active period and the first value and the second value may be different values.

Some examples of the method, apparatuses, and non-transitory computer-readable medium described herein may further include operations, features, means, or instructions for receiving a capability indication message indicating a capability of the UE to support extension of the active period.

In some examples of the method, apparatuses, and non-transitory computer-readable medium described herein, the set of symbols or slots may be allocated for both the SSB transmission and for the random access reception at the UE and the method, apparatuses, and non-transitory computer-readable medium may include further operations, features, means, or instructions for extending the active period of the discontinuous operation mode based on one of the SSB transmission or the random access reception.

In some examples of the method, apparatuses, and non-transitory computer-readable medium described herein, the set of symbols or slots may be allocated for both the SSB transmission and for the random access reception at the UE and the method, apparatuses, and non-transitory computer-readable medium may include further operations, features, means, or instructions for extending the active period of the discontinuous operation mode based on both the SSB transmission and the random access reception.

In some examples of the method, apparatuses, and non-transitory computer-readable medium described herein, the set of symbols or slots may be allocated via one or more separate configurations or a joint configuration for the SSB transmission and for the random access reception.

A method for wireless communications at a UE is described. The method may include receiving a first indication that a network entity in communication with the UE is operating in a discontinuous operation mode, where the discontinuous operation mode includes a cell-based DTX mode, and where the discontinuous operation mode includes an active period and an inactive period that are both within a periodicity, receiving a second indication that one or more symbols or slots are allocated for downlink control channel monitoring by the UE, where the one or more symbols or slots are located within the inactive period of the discontinuous operation mode, initiating an active period of the discontinuous operation mode during the one or more symbols or slots within the inactive period based on at least one of the one or more symbols or slots being within a threshold quantity of symbols or slots from a set of SSB occasions, and participating in communications with the network entity during the initiated active period through the downlink control channel monitoring.

An apparatus for wireless communications at a UE is described. The apparatus may include a processor, memory coupled with the processor, and instructions stored in the memory. The instructions may be executable by the processor to cause the apparatus to receive a first indication that a network entity in communication with the UE is operating in a discontinuous operation mode, where the discontinuous operation mode includes a cell-based DTX mode, and where the discontinuous operation mode includes an active period and an inactive period that are both within a periodicity, receive a second indication that one or more symbols or slots are allocated for downlink control channel monitoring by the UE, where the one or more symbols or slots are located within the inactive period of the discontinuous operation mode, initiate an active period of the discontinuous operation mode during the one or more symbols or slots within the inactive period based on at least one of the one or more symbols or slots being within a threshold quantity of symbols or slots from a set of SSB occasions, and participate in communications with the network entity during the initiated active period through the downlink control channel monitoring.

Another apparatus for wireless communications at a UE is described. The apparatus may include means for receiving a first indication that a network entity in communication with the UE is operating in a discontinuous operation mode, where the discontinuous operation mode includes a cell-based DTX mode, and where the discontinuous operation mode includes an active period and an inactive period that are both within a periodicity, means for receiving a second indication that one or more symbols or slots are allocated for downlink control channel monitoring by the UE, where the one or more symbols or slots are located within the inactive period of the discontinuous operation mode, means for initiating an active period of the discontinuous operation mode during the one or more symbols or slots within the inactive period based on at least one of the one or more symbols or slots being within a threshold quantity of symbols or slots from a set of SSB occasions, and means for participating in communications with the network entity during the initiated active period through the downlink control channel monitoring.

A non-transitory computer-readable medium storing code for wireless communications at a UE is described. The code may include instructions executable by a processor to receive a first indication that a network entity in communication with the UE is operating in a discontinuous operation mode, where the discontinuous operation mode includes a cell-based DTX mode, and where the discontinuous operation mode includes an active period and an inactive period that are both within a periodicity, receive a second indication that one or more symbols or slots are allocated for downlink control channel monitoring by the UE, where the one or more symbols or slots are located within the inactive period of the discontinuous operation mode, initiate an active period of the discontinuous operation mode during the one or more symbols or slots within the inactive period based on at least one of the one or more symbols or slots being within a threshold quantity of symbols or slots from a set of SSB occasions, and participate in communications with the network entity during the initiated active period through the downlink control channel monitoring.

In some examples of the method, apparatuses, and non-transitory computer-readable medium described herein, the threshold quantity of symbols or slots may be a negative value so that the initiated active period may be based on the one or more symbols or slots partially overlapping with the set of SSB occasions.

In some examples of the method, apparatuses, and non-transitory computer-readable medium described herein, the threshold quantity of symbols or slots may be negative one.

In some examples of the method, apparatuses, and non-transitory computer-readable medium described herein, the one or more symbols or slots may be included within the initiated active period within the inactive period based on a periodicity of the set of SSB occasions, a configuration of the cell-based DTX mode, a periodicity of the cell-based DTX mode, the threshold quantity of symbols or slots being overlapping with a set of downlink control channel monitoring occasions, or any combination thereof.

In some examples of the method, apparatuses, and non-transitory computer-readable medium described herein, the initiated active period may be further based on the one or more symbols or slots being located before a beginning of a scheduled active period of the cell-based DTX mode or after an end of the active period of the cell-based DTX mode.

In some examples of the method, apparatuses, and non-transitory computer-readable medium described herein, the threshold quantity of symbols or slots may be a positive value so that the initiated active period may be based on an edge symbol or slot of the one or more symbols or slots being less than the threshold quantity of symbols or slots from a boundary of the set of SSB occasions.

In some examples of the method, apparatuses, and non-transitory computer-readable medium described herein, the downlink control channel monitoring includes one or more downlink control channel occasions located in a UE-specific search space or a common search space set.

In some examples of the method, apparatuses, and non-transitory computer-readable medium described herein, the initiated active period occurs within the inactive period.

A method for wireless communications at a network entity is described. The method may include operating in a discontinuous operation mode, where the discontinuous operation mode is a cell-based DTX mode, and where the discontinuous operation mode includes an active period and an inactive period that are both within a periodicity, allocating one or more symbols or slots for downlink control channel transmission at the network entity, where the one or more symbols or slots are located within the inactive period of the discontinuous operation mode, initiating an active period of the discontinuous operation mode during the one or more symbols or slots within the inactive period based on at least one of the one or more symbols or slots being within a threshold quantity of symbols or slots from a set of SSB occasions, and participating in communications with a UE during the initiated active period through the downlink control channel transmission.

An apparatus for wireless communications at a network entity is described. The apparatus may include a processor, memory coupled with the processor, and instructions stored in the memory. The instructions may be executable by the processor to cause the apparatus to operate in a discontinuous operation mode, where the discontinuous operation mode is a cell-based DTX mode, and where the discontinuous operation mode includes an active period and an inactive period that are both within a periodicity, allocate one or more symbols or slots for downlink control channel transmission at the network entity, where the one or more symbols or slots are located within the inactive period of the discontinuous operation mode, initiate an active period of the discontinuous operation mode during the one or more symbols or slots within the inactive period based on at least one of the one or more symbols or slots being within a threshold quantity of symbols or slots from a set of SSB occasions, and participate in communications with a UE during the initiated active period through the downlink control channel transmission.

Another apparatus for wireless communications at a network entity is described. The apparatus may include means for operating in a discontinuous operation mode, where the discontinuous operation mode is a cell-based DTX mode, and where the discontinuous operation mode includes an active period and an inactive period that are both within a periodicity, means for allocating one or more symbols or slots for downlink control channel transmission at the network entity, where the one or more symbols or slots are located within the inactive period of the discontinuous operation mode, means for initiating an active period of the discontinuous operation mode during the one or more symbols or slots within the inactive period based on at least one of the one or more symbols or slots being within a threshold quantity of symbols or slots from a set of SSB occasions, and means for participating in communications with a UE during the initiated active period through the downlink control channel transmission.

A non-transitory computer-readable medium storing code for wireless communications at a network entity is described. The code may include instructions executable by a processor to operate in a discontinuous operation mode, where the discontinuous operation mode is a cell-based DTX mode, and where the discontinuous operation mode includes an active period and an inactive period that are both within a periodicity, allocate one or more symbols or slots for downlink control channel transmission at the network entity, where the one or more symbols or slots are located within the inactive period of the discontinuous operation mode, initiate an active period of the discontinuous operation mode during the one or more symbols or slots within the inactive period based on at least one of the one or more symbols or slots being within a threshold quantity of symbols or slots from a set of SSB occasions, and participate in communications with a UE during the initiated active period through the downlink control channel transmission.

In some examples of the method, apparatuses, and non-transitory computer-readable medium described herein, the threshold quantity of symbols or slots may be a negative value so that the initiated active period may be based on the one or more symbols or slots partially overlapping with the set of SSB occasions.

In some examples of the method, apparatuses, and non-transitory computer-readable medium described herein, the threshold quantity of symbols or slots may be negative one.

In some examples of the method, apparatuses, and non-transitory computer-readable medium described herein, the one or more symbols or slots may be included within the initiated active period within the inactive period based on a periodicity of the set of SSB occasions, a configuration of the cell-based DTX mode, a periodicity of the cell-based DTX mode, the threshold quantity of symbols or slots being overlapping with a set of downlink control channel monitoring occasions, or any combination thereof.

In some examples of the method, apparatuses, and non-transitory computer-readable medium described herein, the initiated active period may be further based on the one or more symbols or slots being located before a beginning of a scheduled active period of the cell-based DTX mode or after an end of the active period of the cell-based DTX mode.

In some examples of the method, apparatuses, and non-transitory computer-readable medium described herein, the threshold quantity of symbols or slots may be a positive value so that the initiated active period may be based on an edge symbol or slot of the one or more symbols or slots being less than the threshold quantity of symbols or slots from a boundary of the set of SSB occasions.

In some examples of the method, apparatuses, and non-transitory computer-readable medium described herein, the downlink control channel transmission includes one or more downlink control channel occasions located in a UE-specific search space or a common search space set.

In some examples of the method, apparatuses, and non-transitory computer-readable medium described herein, the initiated active period occurs within the inactive period.

### BRIEF DESCRIPTION OF THE DRAWINGS

FIG. 1 shows an example of a wireless communications system that supports extended active period of cellular discontinuous transmission (DTX) and discontinuous reception (DRX) in accordance with one or more aspects of the present disclosure.

FIG. 2 shows an example of a wireless communications system that supports extended active period of cellular DTX and DRX in accordance with one or more aspects of the present disclosure.

FIG. 3 shows example configurations for DTX that supports extended active period of cellular DTX and DRX in accordance with one or more aspects of the present disclosure.

FIG. 4 shows example configurations for DRX that supports extended active period of cellular DTX and DRX in accordance with one or more aspects of the present disclosure.

FIG. 5 shows an example configurations for DTX and DRX that supports extended active period of cellular DTX and DRX in accordance with one or more aspects of the present disclosure.

FIG. 6 shows an example of a process flow that supports extended active period of cellular DTX and DRX in accordance with one or more aspects of the present disclosure.

FIGS. 7 and 8 show block diagrams of devices that support extended active period of cellular DTX and DRX in accordance with one or more aspects of the present disclosure.

FIG. 9 shows a block diagram of a communications manager that supports extended active period of cellular DTX and DRX in accordance with one or more aspects of the present disclosure.

FIG. 10 shows a diagram of a system including a device that supports extended active period of cellular DTX and DRX in accordance with one or more aspects of the present disclosure.

FIGS. 11 and 12 show block diagrams of devices that support extended active period of cellular DTX and DRX in accordance with one or more aspects of the present disclosure.

FIG. 13 shows a block diagram of a communications manager that supports extended active period of cellular DTX and DRX in accordance with one or more aspects of the present disclosure.

FIG. 14 shows a diagram of a system including a device that supports extended active period of cellular DTX and DRX in accordance with one or more aspects of the present disclosure.

FIGS. 15 through 19 show flowcharts illustrating methods that support extended active period of cellular DTX and DRX in accordance with one or more aspects of the present disclosure.

### DETAILED DESCRIPTION

Cellular discontinuous reception (DRX) and discontinuous transmission (DTX) are techniques that may be used to reduce power consumption for both network devices and for user equipment (UE), and to increase overall resource utilization in the network. For example, discontinuous communications such as DRX and DTX may allow network devices and UEs to periodically enter a sleep state during a set of configured “off durations” or non-active periods of a DRX or DTX cycle (e.g., times during which the device is not configured to monitor for or transmit information). The network devices and UEs may then enter a set of configured “on durations,” or active periods, during which the devices may receive or transmit information.

In some cases, however, the network may be configured to transmit one or more types of periodic signaling (e.g., synchronization signal blocks (SSBs)), or to monitor for reception of certain periodically-allowed signals (e.g., random access channel (RACH) transmissions from the UE). When these periodic signals (or resources reserved for such periodic signals) are allocated during a cell-based DTX or DRX inactive or “off” duration, then the network entity may respond according to one or more different courses of action. In some examples, the network entity may remain in the inactive or “off” duration and ignore transmission of an SSB or neglect to monitor for RACH, or the network entity may exit its DTX or DRX modes and proceed to transmit SSB or monitor for RACH. In some cases, however, such inefficiencies in handling the periodic signaling may result in increased systemwide latency and increased energy expenditure.

To efficiently handle periodic signaling that is scheduled for an inactive period or active duration of DRX or DTX, the network or the UE may determine whether to “extend” an active period of its DTX or DRX operation in order to transmit or receive SSBs or to transmit or monitor for RACH. For example, a device may extend the active period in cases where scheduled SSB or RACH occasions are within a threshold quantity of slots or symbols from the non-extended active period. In a first example, if at least one slot containing SSB or RACH overlaps with the active period (while other slots or symbols associated with a same SSB burst or RACH do not overlap with the active period), the active period may be extended to include all of the slots or symbols containing SSBs associated with the same SSB burst or associated RACH messages (e.g., for either overlapping SSB bursts or RACH messages that occur before the active period or after the active period). In a second example, the active period may be extended if the time gap between the end of a slot containing the last SSB or RACH and the start of the active time is “X” symbols or slots or less, or if the time gap between the start of slot containing the first SSB or RACH and the end of the active time is “Y” symbols or slots or less. In such cases, the active time may be extended beyond X to start at the slot containing the first SSB or RACH, or the active time may be extended beyond Y to end after the slot containing the last SSB.

Aspects of the disclosure are initially described in the context of wireless communications systems. Aspects of the disclosure are further illustrated by and described with reference to configurations for DRX and DTX, a process flow apparatus diagrams, system diagrams, and flowcharts that relate to extended active period of cellular DTX and DRX.

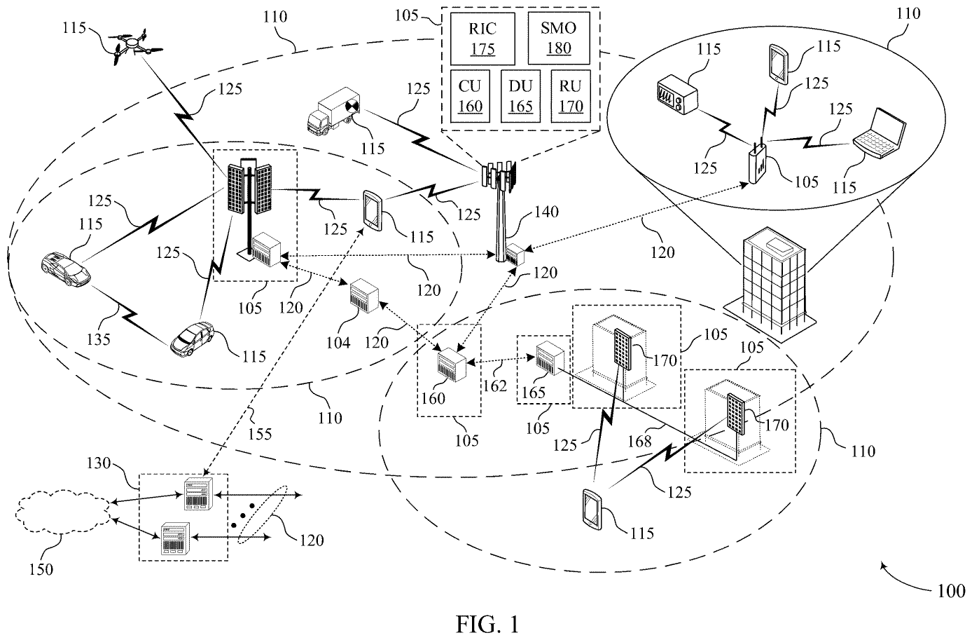

FIG. 1 shows an example of a wireless communications system 100 that supports extended active period of cellular DTX and DRX in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125.

The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (VIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 via an interface (e.g., a backhaul link). IAB donor and IAB nodes 104 may communicate via an F1 interface according to a protocol that defines signaling messages (e.g., an F1 AP protocol).

Additionally, or alternatively, the CU 160 may communicate with the core network via an interface, which may be an example of a portion of backhaul link, and may communicate with other CUs 160 (e.g., a CU 160 associated with an alternative IAB donor) via an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN.

Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, or referred to as a child IAB node associated with an IAB donor, or both. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, or may directly signal transmissions to a UE 115, or both. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling via an NR Uu interface to MT of the IAB node 104.

Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support extended active period of cellular DTX and DRX as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IOT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., Nf) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a carrier may support multiple cells, and different cells may be configured according to different protocol types (e.g., MTC, narrowband IoT (NB-IOT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHZ.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

A UE 115 and a network entity 105 may implement cellular DRX and cellular DTX to reduce power consumption, and to increase resource utilization, and overall scheduling efficiency. For example, the UE 115 and the network entity 105 may periodically enter a sleep state during a set of configured “off durations” or non-active periods of a DRX or DTX cycle, and correspondingly may enter a set of configured “on durations,” or active periods, during which the devices may receive or transmit information. In some cases, however, the network entity 105 and the UE 115 may be configured to transmit or receive some types of periodic signalizing (e.g., SSBs or RACH) during a cell-based DTX or DRX inactive or “off” duration. The network entity may respond according to one or more different courses of action, including ignoring transmission of an SSB or neglect to monitor for RACH, exiting its DTX or DRX modes and proceed to transmit SSB or monitor for RACH. In some cases, however, such inefficiencies in handling the periodic signaling may result in increased systemwide latency and increased energy expenditure.

To efficiently handle periodic signaling that is scheduled for an inactive period of DRX or DTX, the network entity 105 or the UE 115 may determine whether to “extend” an active period of its DTX or DRX operation in order to transmit or receive SSBs or to transmit or monitor for RACH. For example, a device may extend the active period in cases where scheduled SSB or RACH occasions are within a threshold quantity of slots or symbols from the non-extended active period. In a first example, if at least one slot or symbol containing SSB or RACH overlaps with the active period (while other slots or symbols associated with a same SSB burst or RACH do not overlap with the active period), the active period may be extended to include all of the slots or symbols containing SSBs associated with the same SSB burst or associated RACH messages (e.g., for either overlapping SSB bursts or RACH messages that occur before the active period or after the active period). In a second example, the active period may be extended if the time gap between the end of a slot or symbol containing the last SSB or RACH and the start of the active time is “X” symbols or slots or less, or if the time gap between the start of slot or symbol containing the first SSB or RACH and the end of the active time is “Y” symbols or slots or less.

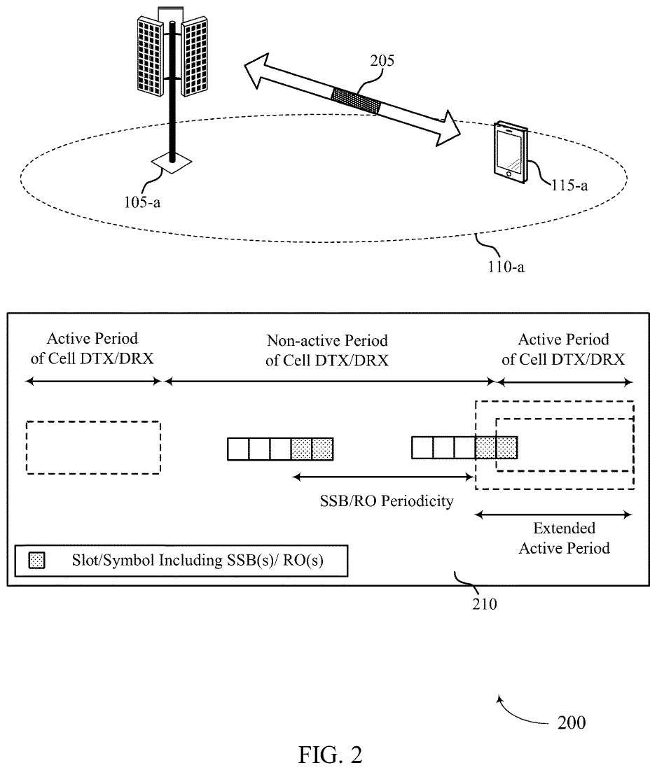

FIG. 2 shows an example of a wireless communications system 200 that supports extended active period of cellular DTX and DRX in accordance with one or more aspects of the present disclosure. For example, wireless communications system 200 may support communications between a UE 115-a and a network entity 105-a, each of which may be examples of corresponding devices described with reference to FIG. 1.

Cellular DRX and DTX may be implemented by wireless communications system 200 to reduce network power consumption and to increase overall resource utilization by allowing network devices to periodically enter a sleep state during a set of configured “off durations” or non-active periods of a DRX or DTX cycle (e.g., times during which the device does not need to monitor for or transmit information). In some examples, the UE 115-a may be configured with DRX or DTX while operating in an RRC connected (e.g., RRC_Connected) mode, and may support DRX and DTX alignment and inter-node information exchange using DRX and DTX.

The UE 115-a may receive the configuration for DRX or DTX via UE-specific signaling (e.g., the RRC configuration may be UE-specific), or via common signaling for some or all of the UEs in the cell 110-a. Additionally or alternatively, the configuration for cellular DTX may be the same as the configuration for cellular DRX, or the configuration for cellular DTX may be different from the configuration for cellular DRX.

The UE 115-a may receive a periodic cell DTX or DRX configuration 205 that includes periodicity information (e.g., a periodicity with which the UE 115-a is configured to transmit or receive communications), starting slot or slot offset information, “on” duration or active period, among other configuration information. The cellular DTX configuration, cellular DRX configuration, or both, may be activated or deactivated implicitly by RRC signaling. For example, the cellular DTX or DRX configuration 205 may be activated or implemented by the UE 115-a once configured by RRC signaling, and deactivated once the RRC configuration is released. In some other examples, the UE 115-a may receive layer-1 (L1) signaling which may enable or disable the cellular DTX and DRX operation. In such examples, the cell 110-a may support up to a threshold quantity of connected mode UEs (e.g., for low to medium cell loading, and the LI signaling may be used for disabling or enabling the cellular DTX and DRX operation according to the loading of the cell 110-a.

To support network power savings, the network entity 105-a may refrain from transmitting physical channels or other signaling during the non-active period or “off” period of cellular DTX. Similarly, the network entity 105-a may refrain from receiving physical channels or other signaling during the non-active period or “off” period of cellular DRX. In such cases, the network entity 105-a may remain in an inactive sleep state to conserve network power and increase power savings. Additionally or alternatively, the UE 115-a may refrain from transmitting physical channels or other signaling during the non-active period or “off” period of cellular DTX. The UE 115-a may also refrain from receiving physical channels or other signaling during the non-active period or “off” period of cellular DRX. In such cases, the UE 115-a may remain in an inactive or idle state to conserve battery power.

Some physical channels or signals supporting RRC idle UEs (or inactive mode UEs) may be maintained (e.g., not dropped) during the non-active period or “off” period of cellular DTX or during the non-active period “off” period of cellular DRX. In such cases, the UE 115-a may, in at least some examples, receive or transmit such physical signals or channels during the non-active period. For example, the UE 115-a may receive SSBs from the network entity 105-a, PDCCH and PDSCH (e.g., for paging information and system information), RACH related channels, synchronization signals, or any combination thereof.

In some other examples, the UE 115-a may refrain from receiving or monitoring some physical channels and signals during the non-active period or “off” period of cellular DTX, or the UE 115-a may refrain from transmitting some physical channels or signals during the non-active period or “off” period of cellular DTX. For example, in at least some DTX cases, the UE 115-a may refrain from transmitting some uplink channels including configured grant PUSCH, SPS, PUCCH carrying periodic or semi-persistent CSI reports, PUSCH carrying semi-persistent CSI reports, or any combination thereof. Additionally or alternatively, in at least some DRX cases, the UE 115-a may refrain from receiving SPS, periodic or semi-persistent CSI-RS for CSI reporting, or any combination thereof.

In some implementations of DRX and DTX, the network entity 105-a and the UE 115-a may be configured to transmit or receive one or more types of periodic signaling while also being configured with DRX or DTX communication. For example, the network entity 105-a may be configured to transmit SSBs and the UE 115-a may be configured to receive such SSBs, or the network entity 105-a may be configured to monitor for RACH transmissions from the UE 115-a. When these periodic signals (or resources reserved for such periodic signals) are allocated during a cell-based DTX or DRX inactive or “off” duration, then the network entity may respond in one or more different ways. For example, the network entity may remain in the inactive or “off” duration and ignore transmission of an SSB or neglect to monitor for RACH, or the network entity may exit its DTX or DRX modes and proceed to transmit SSB or monitor for RACH.

In some other examples, however, the network entity 105-a and the UE 115-a may consider the non-active period of the cellular DTX or DRX (for SSB and RACH communications) as active periods. In such examples, the network entity 105-a may increase its active period such that if the network entity 105-a wakes up for SSB transmission, it may be able to perform additional operations performed during the active period. In addition, the network entity 105-a, the UE 115-a, or both, may communicate physical channels or signals during the non-active period to increase resource utilization. In some other examples, the cellular DTX and cellular DRX configurations facilitates UE processing and handling such that the cellular DTX or DRX pattern may be affected along with UE processing if the UE 115-a treats slots or symbols containing SSBs or RACH occasions as part of the active period of cellular DTX or DRX.

To support efficient SSB and RACH signaling that is coordinated with DTX and DRX, the network entity 105-a and the UE 115-a may support techniques to “extend” an active period of DTX or DRX operation in order to transmit or receive SSBs or transmit RACH or monitor for RACH. For example, the UE 115-a and the network entity 105-a may support extending the active period via an active period extension procedure 210 (or other active period extension procedure) in cases where scheduled SSB or RACH occasions are within a threshold quantity of slots or symbols from the non-extended active period. In such examples, the active period may be extended based on the slots or symbols containing SSBs or RACH occasions in the non-active period of cellular DTX or cellular DRX satisfying one or more conditions.

In a first implementation, if at least one slot or symbol containing SSB or RACH overlaps with the active period (while other slots associated with a same SSB burst or RACH do not overlap with the active period), the active period may be extended to include all of the slots or symbols containing SSBs associated with the same SSB burst or associated RACH messages. The rules for extending the active period may apply for either overlapping SSB bursts or RACH messages that occur before the active period or after the active period. In a second implementation, the active period may be extended if the time gap between the end of a slot or symbol containing the last SSB or RACH and the start of the active period is “X” symbols or slots or less, or if the time gap between the start of slot or symbol containing the first SSB or RACH and the end of the active period is “Y” symbols or slots or less. In such cases, the active period may be extended beyond X to start at the slot or symbol containing the first SSB or RACH, or the active period may be extended beyond Y to end after the slot or symbol containing the last SSB.

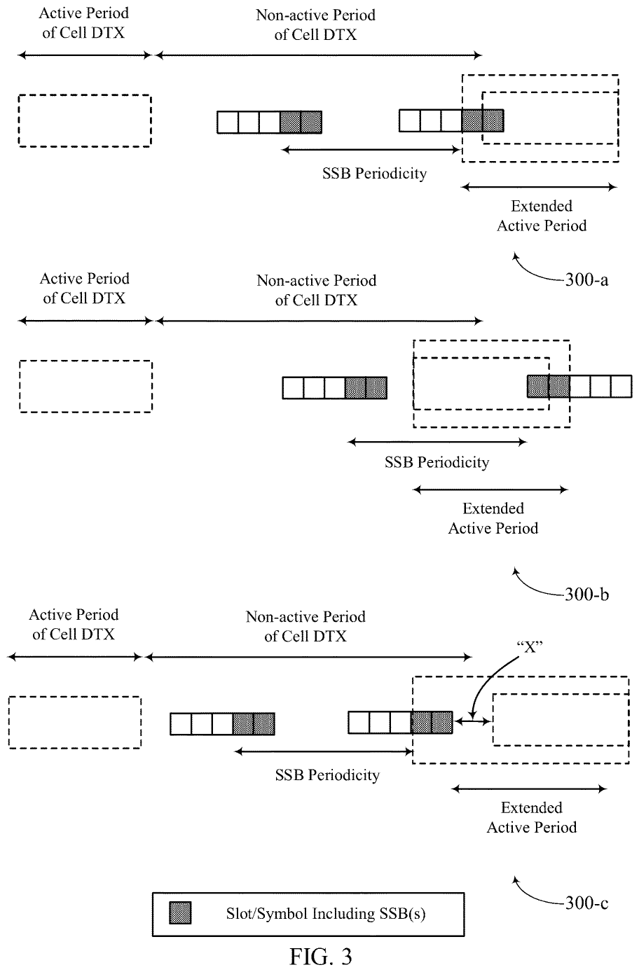

FIG. 3 shows an example of a configuration 300-a, configuration 300-b, and configuration 300-c for DTX that supports extended active period of cellular DTX and DRX in accordance with one or more aspects of the present disclosure. For example, the configuration 300-a, configuration 300-b, and configuration 300-c may be supported or implemented at or by a UE or network entity. The UE, the network entity, or both, may be capable of supporting active period extension for DTX, DRX, or both.

To support efficient SSB signaling that is coordinated with DTX, a UE and a network entity may support techniques to “extend” an active period of DTX to transmit SSBs during an extended active period. For example, a network entity may support extending the active period to transmit SSBs, and the UE may determine the start of the active period of the cellular DTX based on SSB transmission. In some examples, the network entity may extend the active period based on one or more conditions, such as when scheduled SSBs are determined to be within a threshold quantity of slots or symbols from the non-extended active period.

At configuration 300-a, at least one slot or symbol that includes a first set of transmitted or scheduled SSBs overlaps with the active period, and one or more other slots or symbols that include a second set of transmitted or scheduled SSBs that do not overlap with the active period may precede the start of the active period. The transmission of SSBs may be configured according to an SSB periodicity. In such examples, the network entity may extend the active period to include one or more of the second set of transmitted or scheduled SSBs that occur before the active period, such that the one or more other slots or symbols (that were previously within the non-active period) are included within the extended active period.

At configuration 300-b, at least one slot or symbol that includes a first set of transmitted or scheduled SSBs overlap with the active period, and one or more other slots or symbols that include a second set of transmitted or scheduled SSBs that do not overlap with the active period may occur after the end of the active period. The transmission of SSBs may be configured according to an SSB periodicity. In such examples, the network entity may extend the active period to include one or more of the second set of transmitted or scheduled SSBs that occur after the active period, such that the one or more other slots or symbols (that were previously within the non-active period) are included within the extended active period.

Additionally or alternatively, the network entity may extend the active period for one or more slots or symbols containing the transmitted or scheduled SSBs that do not overlap with the active period in cases in which the slots or symbols precede the start of the active period, or in cases in which the slots or symbols occur after the end of the active period. In such cases, the network entity may be restricted to extending the active period for slots or symbols including SSBs occurring before the existing active period or for slots or symbols including SSBs occurring after the existing active period. For example, the UE may allow for active period extension for only for cases where the symbol or slot is located before the start of the active period, or only for cases where the symbol or slot is located after the end of the active period.

At configuration 300-c, the time gap between the end of slot that includes a sequentially last transmitted or scheduled SSB and the start of the active period is “X” symbols or slots, or the time gap between the start of a slot or symbol containing the sequentially first transmitted or scheduled SSB (e.g., a first SSB transmitted outside of the active period) and the end of the active period is “Y” symbols or slots. In such cases, the time gap X, the time gap Y, or both, may be a fixed number of slots (e.g., X is equal to 0 or 1 slot, Y is equal to 0 or 1 slot), which may be configurable by RRC signaling. In some other examples, X, Y, or both, may be configured based on a UE capability (e.g., a UE capability to support active period extension, or one or more other UE capabilities). Additionally or alternatively, the time gap X and Y may be configured as a same time gap or may be configured as different time gaps, and the first or last SSB transmitted outside the active period may be the sequentially first or last SSB of the set of SSBs transmitted in one SSB transmission occasion, or may be a different SSB from the sequentially first or last SSB of the set of SSBs transmitted in one SSB transmission occasion.

In examples of 300-c where at least one slot that includes a transmitted or scheduled SSB occurs before the start of the active period, the extended active period may start from the slot including the first SSB transmitted outside of the active period. In some other examples, if at least one slot or symbol that includes a transmitted or scheduled SSB occurs after the end of the active period, the active period may be extended to the end of the slot or symbol containing the sequentially last transmitted SSB outside of the active period.

A UE may identify the locations of one or more transmitted SSBs for the purpose of active period determination based on system information signaling. For example, the UE may receive a first type of system information block (e.g., SIB1) that includes one or more fields (e.g., ssb-PositionsInBurst) that indicates the location of transmitted SSBs (e.g., actually transmitted SSBs out of all scheduled SSBs). In such examples, the ssb-PositionsInBurst provides the actually-transmitted SSBs from a set of all SSBs in a single SSB transmission occasion or SSB burst. In some other examples, the UE may assume that all scheduled SSBs are transmitted. For example, even in cases that ssb-PositionsInBurst in SIB1 indicates that not all SSBs will be actually transmitted during the set of slots for SSB transmission, the UE may still assume that all of the SSBs in this set are transmitted and use a full SSB pattern in this set to determine active period extension (e.g., the UE can assume that all SSBs in a set of slots allocated for SSBs or all SSBs in an SSB burst set or transmission occasion will be transmitted). Additionally or alternatively, the UE may transmit a UE capability message that indicates the UEs capability for supporting active period extension based on SSB transmissions.

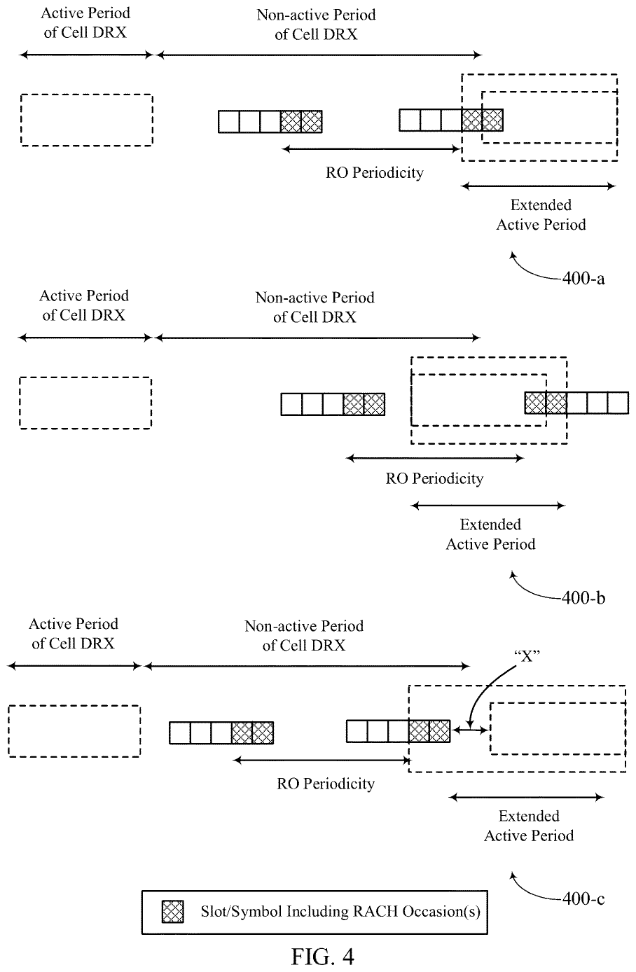

FIG. 4 shows an example of a configuration 400-a, a configuration 400-b, and a configuration 400-c for DRX that supports extended active period of cellular DTX and DRX in accordance with one or more aspects of the present disclosure. For example, the configuration 400-a, the configuration 400-b, and the configuration 400-c may be supported or implemented at or by a UE or network entity. The UE, the network entity, or both, may be capable of supporting active period extension for DTX, DRX, or both.

To support RACH signaling that is coordinated with DRX, a UE and a network entity may support techniques to “extend” an active period of DRX to transmit RACH in a RACH occasion during an extended active period. For example, a UE may support extending the active period to transmit RACH, and may determine the start of the active period of the cellular DRX based on RACH transmission. In some examples, the UE may extend the active period based on one or more conditions, such as when RACH occasions are determined to be within a threshold quantity of slots or symbols from the non-extended active period.

At configuration 400-a, at least one slot or symbol that includes a first set of one or more RACH occasions overlaps with the active period and one or more other slots or symbols that include a second set of one or more RACH occasions that do not overlap with the active period may precede the start of the active period. In such examples, the UE may extend the active period to include the second set of one or more RACH occasions that occur before the active period, such that the one or more other slots or symbols (that were previously within the non-active period) are included within the extended active period.

At configuration 400-b, at least one slot or symbol that includes a first set of one or more RACH occasions overlaps with the active period and one or more other slots that include a second set of one or more RACH occasions that do not overlap with the active period may occur after the end of the active period. In such examples, the UE may extend the active period to include the second set of one or more RACH occasions that occur after the active period, such that the one or more other slots or symbols (that were previously within the non-active period) are included within the extended active period.

Additionally or alternatively, the UE may extend the active period for one or more slots or symbols containing the RACH occasions that do not overlap with the active period when the one or more slots or symbols precede the start of the active period, or when the slots or symbols occur after the end of the active period. In such cases, the UE may be restricted to extending the active period for slots or symbols including RACH occasions occurring before the existing active period or for slots or symbols including RACH occasions occurring after the existing active period. For example, the UE may allow for active period extension for only for cases where the symbol or slot is located before the start of the active period, or only for cases where the symbol or slot is located after the end of the active period.

At configuration 400-c, the time gap between the end of slot or symbol that includes a sequentially last RACH occasion and the start of the active period is “X” symbols or slots, or the time gap between the start of slot or symbol containing the sequentially first RACH occasion and the end of the active period is “Y” symbols or slots. In such cases, the time gap X, the time gap Y, or both, may be a fixed number of slots (e.g., X is equal to 0 or 1 slot, Y is equal to 0 or 1 slot), which may be configurable by RRC signaling. In some other examples, X, Y, or both, may be configured based on a UE capability (e.g., a UE capability to support active period extension, or one or more other UE capabilities). Additionally or alternatively, the time gap X and Y may be configured as a same time gap or may be configured as different time gaps.

In examples of 400-c where at least one slot that includes a RACH occasion occurs before the start of the active period, the extended active period may start from the slot or symbol including the first RACH occasion. In some other examples, if at least one slot or symbol that includes a RACH occasion occurs after the end of the active period, the active period may be extended to the end of the slot or symbol containing the sequentially last RACH occasion.

A UE may identify the locations of one or more RACH occasions for the purpose of active period determination based on system information signaling. For example, the UE may receive a first type of system information block (e.g., SIB1) that includes one or more RACH configurations that indicate the location of a set of RACH occasions. In some other examples, the UE may transmit a UE capability message that indicates the UEs capability for supporting active period extension based on RACH occasions.

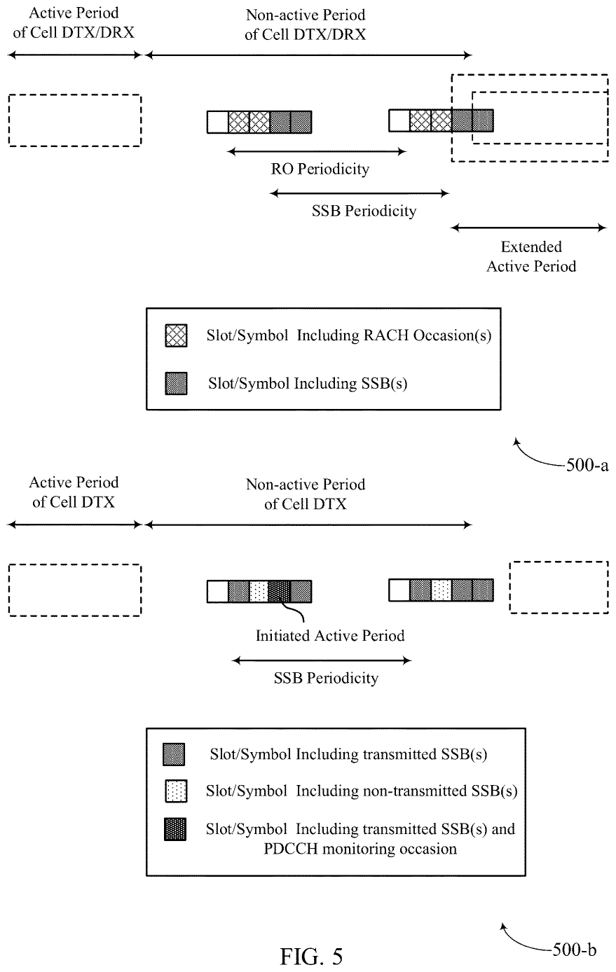

FIG. 5 shows an example of a configuration 500-a and 500-b for discontinuous communications that supports extended active period of cellular DTX and DRX in accordance with one or more aspects of the present disclosure. For example, the configuration 500-a and 500-b may be supported or implemented at or by a UE or network entity. The UE, the network entity, or both, may be capable of supporting active period extension for DTX, DRX, or both.

In some implementations, such as for configuration 500-a cellular DTX and cellular DRX may be separately configured such that configuration parameters (e.g., periodicity, starting slot, slot offset, and active period) are configured separately for cellular DTX and cellular DRX. In some other implementations, for example in unpaired spectrum deployments (e.g., time division duplexing (TDD) deployments) cellular DTX and cellular DRX may be jointly configured such that configuration parameters (e.g., periodicity, starting slot, slot offset, and active period) are the same for both cellular DTX and cellular DRX.

When a UE is jointly configured with cellular DTX and DRX, the UE may determine the extended cell active period based on respective configurations for SSB transmission, RACH occasions, or both. In some examples, the UE may determine the extended cell active period based on SSB transmission or the SSB configuration. In some other examples, the UE may determine the extended cell active period based on RACH occasions or the RACH configuration. In some other examples, the UE may determine the extended cell active period based on both SSB transmission and RACH occasions.

For configuration 500-b, the active period can be initiated within the non-active period based on one or more conditions being satisfied. For example, a symbol or slot containing SSBs for transmission or reception may be considered as part of the active period of cellular DTX based on SSB periodicity, cellular DTX configuration (e.g., cellular DTX periodicity), the overlapping configuration between symbols or slots and one or more physical downlink control channel monitoring occasions, or any combination thereof. In some examples, the UE may wake up during the non-active period in order to monitor PDCCH for SSB reception (e.g., in addition to or instead of extending the active duration).

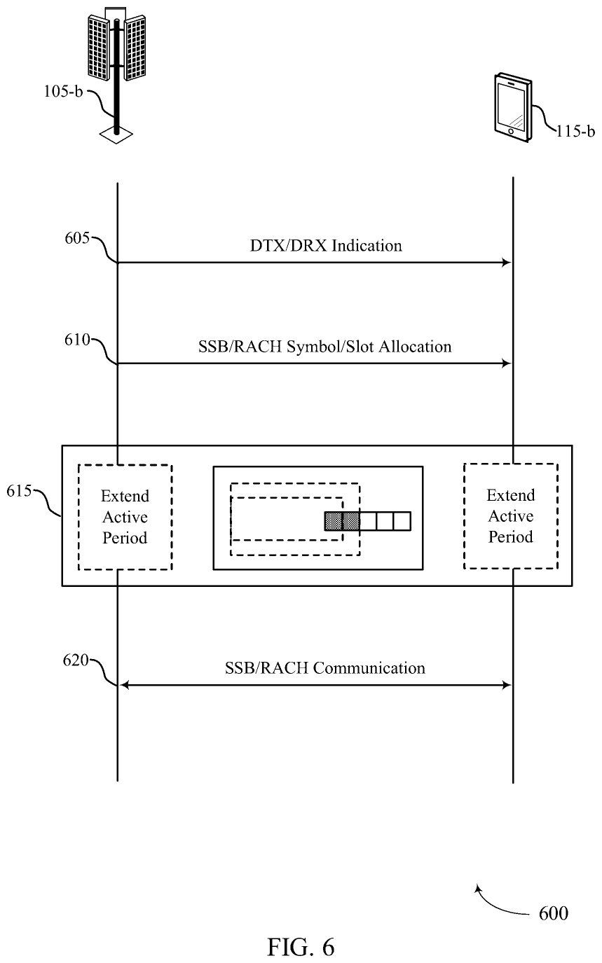

FIG. 6 shows an example of a process flow 600 that supports extended active period of cellular DTX and DRX in accordance with one or more aspects of the present disclosure. The process flow 600 illustrates a process for extending the active period for SSB communications, RACH communications, or both. Communications illustrated by the process flow 600 may occur between a UE 115-b and a network entity 105-b, each of which may be examples of UEs 115 and network entities 105 described herein. In the following description of process flow 600, the operations may be performed in a different order than the order shown, or other operations may be added or removed from the process flow 600. For example, some operations may also be left out of process flow 600, may be performed in different orders or at different times, or other operations may be added to process flow 600. Although the network entity 105-b and the UE 115-b are shown performing the operations of process flow 600, some aspects of some operations may also be performed by one or more other wireless or network devices.

At 605, the UE 115-b may receive a first indication that the network entity 105-b is operating in a discontinuous operation mode (e.g., a cell-based DTX mode, a cell-based DRX mode, or both) that includes both an active period and an inactive period that are both within a periodicity.

At 610, the UE 115-b may receive a second indication that a set of symbols or slots are allocated for SSB reception at the UE 115-b or for random access transmission at the UE 115-b. In some examples, the set of symbols or slots may at least partially overlap with the inactive period of the discontinuous operation mode. In some examples, the UE 115-b may receive the second indication via a system information block (e.g., SIB1), where the second indication indicates one or more locations for the SSB reception or the random access transmission at the UE 115-b.

In some examples, the UE 115-b may transmit a capability indication message indicating a capability of the UE 115-b to support extension of the active period for the SSB reception or for the random access transmission.

At 615, the UE 115-b may extend the active period of the discontinuous operation mode to overlap the set of symbols or slots based on at least one of the set of symbols or slots being within a threshold quantity of slots from the active period prior to extension of the active period. For example, in some cases, the threshold quantity of slots is a negative value (e.g., −1) so that extension of the active period is based on the set of symbols or slots partially overlapping with the active period prior to extension of the active period. In such cases that the threshold quantity of slots is a negative value, at last one symbol or slot of the set of symbols or slots is already overlapping with the active period, and the extension of the active period extends the active period to include one or more symbols or slots that were previously outside of the active period.

In some other cases, the threshold quantity of slots may be a positive value such that extension of the active period is based on an edge slot of the set of symbols or slots being less than the threshold quantity of slots from a boundary of the active period prior to extension. In such cases, the edge slot may be a sequentially last slot of the set of symbols or slots or a sequentially first slot of the set of symbols or slots, and the boundary may be a beginning of the active period or an ending of the active period prior to extension. In some examples, the UE 115-b may shift the beginning of the active period to begin at a first slot of the set of symbols or slots, or the UE 115-b may shift the ending of the active period to end at a last slot of the set of symbols or slots. The threshold quantity of slots may be a fixed value, a value configured by RRC signaling, a value that is based on one or more capabilities of the UE 115-b, or any combination thereof.

In some examples, the threshold quantity of slots is a first value when extension of the active period includes a shifting of a beginning of the active period. Additionally or alternatively, the threshold quantity of slots is a second value when extension of the active period includes a shifting of an ending of the active period, where the first value and the second value are a same value. In some other examples, the threshold quantity of slots is a first value when extension of the active period includes a shifting of a beginning of the active period, and a second value when extension of the active period includes a shifting of an ending of the active period, where the first value and the second value are different values.

In some examples, the UE 115-b may extend the active period of the discontinuous operation mode based on the set of symbols or slots being located before a start of the active period or after an end of the active period prior to extension. In some examples, the set of symbols or slots may be allocated for both the SSB reception and for the random access transmission, and the UE 115-b may determine to extend the active period of the discontinuous operation may based on one of the SSB reception or the random access transmission, or based on both the SSB reception and the random access transmission. In such cases, the SSB reception and random access transmission may be jointly or separately configured.

At 620, the UE 115-b may participate in communications with the network entity 105-b during the extended active period through the SSB reception or the random access transmission.

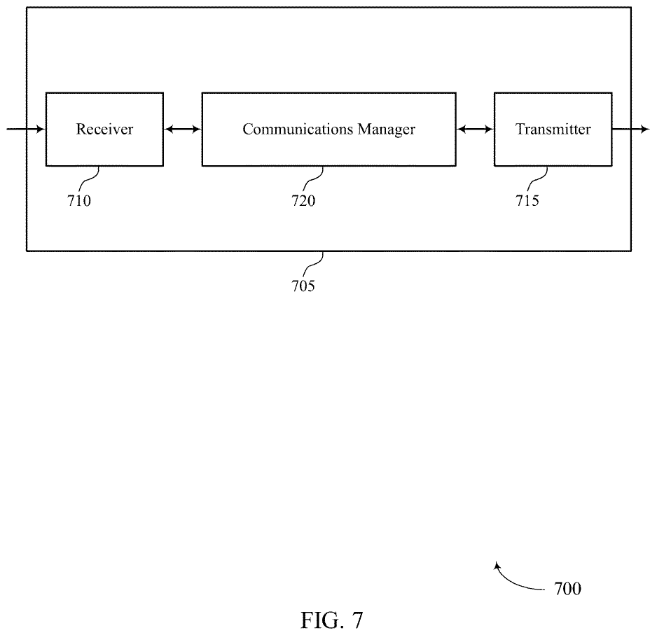

FIG. 7 shows a block diagram 700 of a device 705 that supports extended active time of cellular DTX and DRX in accordance with one or more aspects of the present disclosure. The device 705 may be an example of aspects of a UE 115 as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to extended active time of cellular DTX and DRX). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to extended active time of cellular DTX and DRX). In some examples, the transmitter 715 may be co-located with a receiver 710 in a transceiver module. The transmitter 715 may utilize a single antenna or a set of multiple antennas.

The communications manager 720, the receiver 710, the transmitter 715, or various combinations thereof or various components thereof may be examples of means for performing various aspects of extended active time of cellular DTX and DRX as described herein. For example, the communications manager 720, the receiver 710, the transmitter 715, or various combinations or components thereof may support a method for performing one or more of the functions described herein.

In some examples, the communications manager 720, the receiver 710, the transmitter 715, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 720, the receiver 710, the transmitter 715, or various combinations or components thereof may be implemented in code (e.g., as communications management software or firmware) executed by a processor. If implemented in code executed by a processor, the functions of the communications manager 720, the receiver 710, the transmitter 715, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 720 may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications at a UE in accordance with examples as disclosed herein. For example, the communications manager 720 is capable of, configured to, or operable to support a means for receiving a first indication that a network entity in communication with the UE is operating in a discontinuous operation mode, where the discontinuous operation mode is a cell-based DTX mode, a cell-based DRX mode, or both, and where the discontinuous operation mode includes an active duration and an inactive duration that are both within a periodicity. The communications manager 720 is capable of, configured to, or operable to support a means for receiving a second indication that a set of symbols or slots is allocated for SSB reception at the UE for the cell-based DTX mode or for random access transmission at the UE for the cell-based DRX mode, where the set of symbols or slots at least partially overlaps with the inactive duration of the discontinuous operation mode. The communications manager 720 is capable of, configured to, or operable to support a means for extending the active duration of the discontinuous operation mode to overlap the set of symbols or slots based on at least one of the set of symbols or slots being within a threshold quantity of symbols or slots from the active duration prior to extension. The communications manager 720 is capable of, configured to, or operable to support a means for participating in communications with the network entity during the extended active duration through the SSB reception or the random access transmission.

Additionally, or alternatively, the communications manager 720 may support wireless communications at a UE in accordance with examples as disclosed herein. For example, the communications manager 720 is capable of, configured to, or operable to support a means for receiving a first indication that a network entity in communication with the UE is operating in a discontinuous operation mode, where the discontinuous operation mode includes a cell-based DTX mode, and where the discontinuous operation mode includes an active duration and an inactive duration that are both within a periodicity. The communications manager 720 is capable of, configured to, or operable to support a means for receiving a second indication that one or more symbols or slots are allocated for downlink control channel monitoring by the UE, where the one or more symbols or slots are located within the inactive duration of the discontinuous operation mode. The communications manager 720 is capable of, configured to, or operable to support a means for initiating an active duration of the discontinuous operation mode during the one or more symbols or slots within the inactive duration based on at least one of the one or more symbols or slots being within a threshold quantity of symbols or slots from a set of SSB occasions. The communications manager 720 is capable of, configured to, or operable to support a means for participating in communications with the network entity during the initiated active duration through the downlink control channel monitoring.

By including or configuring the communications manager 720 in accordance with examples as described herein, the device 705 (e.g., a processor controlling or otherwise coupled with the receiver 710, the transmitter 715, the communications manager 720, or a combination thereof) may support techniques for reduced processing, reduced power consumption, more efficient utilization of communication resources, and more efficient handling of DRX and DTX communications.

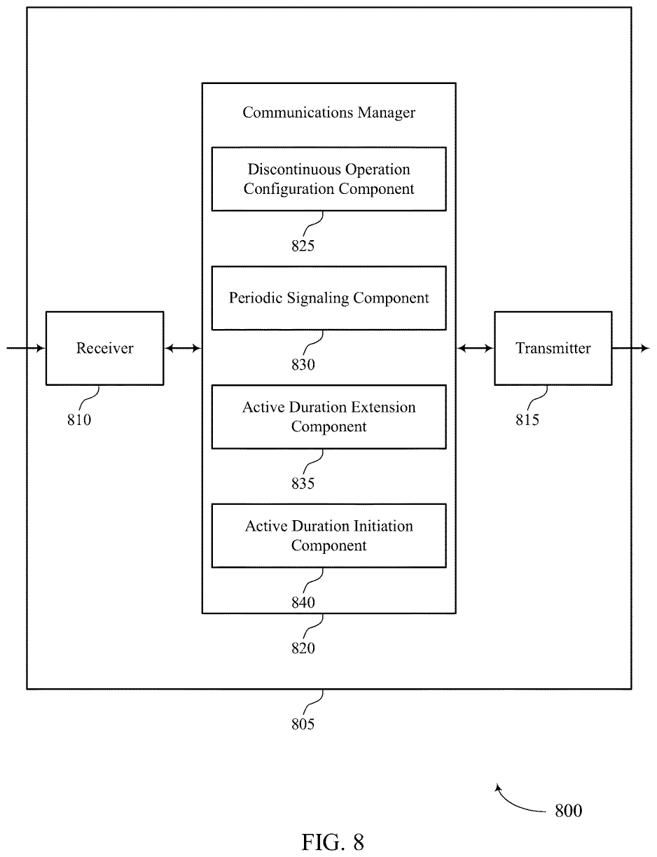

FIG. 8 shows a block diagram 800 of a device 805 that supports extended active time of cellular DTX and DRX in accordance with one or more aspects of the present disclosure. The device 805 may be an example of aspects of a device 705 or a UE 115 as described herein. The device 805 may include a receiver 810, a transmitter 815, and a communications manager 820. The device 805 may also include a processor. Each of these components may be in communication with one another (e.g., via one or more buses).

The receiver 810 may provide a means for receiving information such as packets, user data, control information, or any combination thereof associated with various information channels (e.g., control channels, data channels, information channels related to extended active time of cellular DTX and DRX). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to extended active time of cellular DTX and DRX). In some examples, the transmitter 815 may be co-located with a receiver 810 in a transceiver module. The transmitter 815 may utilize a single antenna or a set of multiple antennas.

The device 805, or various components thereof, may be an example of means for performing various aspects of extended active time of cellular DTX and DRX as described herein. For example, the communications manager 820 may include a discontinuous operation configuration component 825, a periodic signaling component 830, an active duration extension component 835, an active duration initiation component 840, or any combination thereof. The communications manager 820 may be an example of aspects of a communications manager 720 as described herein. In some examples, the communications manager 820, or various components thereof, may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communications at a UE in accordance with examples as disclosed herein. The discontinuous operation configuration component 825 is capable of, configured to, or operable to support a means for receiving a first indication that a network entity in communication with the UE is operating in a discontinuous operation mode, where the discontinuous operation mode is a cell-based DTX mode, a cell-based DRX mode, or both, and where the discontinuous operation mode includes an active duration and an inactive duration that are both within a periodicity. The periodic signaling component 830 is capable of, configured to, or operable to support a means for receiving a second indication that a set of symbols or slots is allocated for SSB reception at the UE for the cell-based DTX mode or for random access transmission at the UE for the cell-based DRX mode, where the set of symbols or slots at least partially overlaps with the inactive duration of the discontinuous operation mode. The active duration extension component 835 is capable of, configured to, or operable to support a means for extending the active duration of the discontinuous operation mode to overlap the set of symbols or slots based on at least one of the set of symbols or slots being within a threshold quantity of symbols or slots from the active duration prior to extension. The periodic signaling component 830 is capable of, configured to, or operable to support a means for participating in communications with the network entity during the extended active duration through the SSB reception or the random access transmission.

Additionally, or alternatively, the communications manager 820 may support wireless communications at a UE in accordance with examples as disclosed herein. The discontinuous operation configuration component 825 is capable of, configured to, or operable to support a means for receive a first indication that a network entity in communication with the UE is operating in a discontinuous operation mode, where the discontinuous operation mode includes a cell-based DRX mode, and where the discontinuous operation mode includes an active duration and an inactive duration that are both within a periodicity. The discontinuous operation configuration component 825 is capable of, configured to, or operable to support a means for receive a second indication that one or more symbols or slots are allocated for downlink control channel monitoring by the UE, where the one or more symbols or slots are located within the inactive duration of the discontinuous operation mode. The active duration initiation component 840 is capable of, configured to, or operable to support a means for initiate an active duration of the discontinuous operation mode during the one or more symbols or slots within the inactive duration based on at least one of the one or more symbols or slots being within a threshold quantity of symbols or slots from a set of SSB occasions. The periodic signaling component 830 is capable of, configured to, or operable to support a means for participate in communications with the network entity during the initiated active duration through the downlink control channel monitoring.

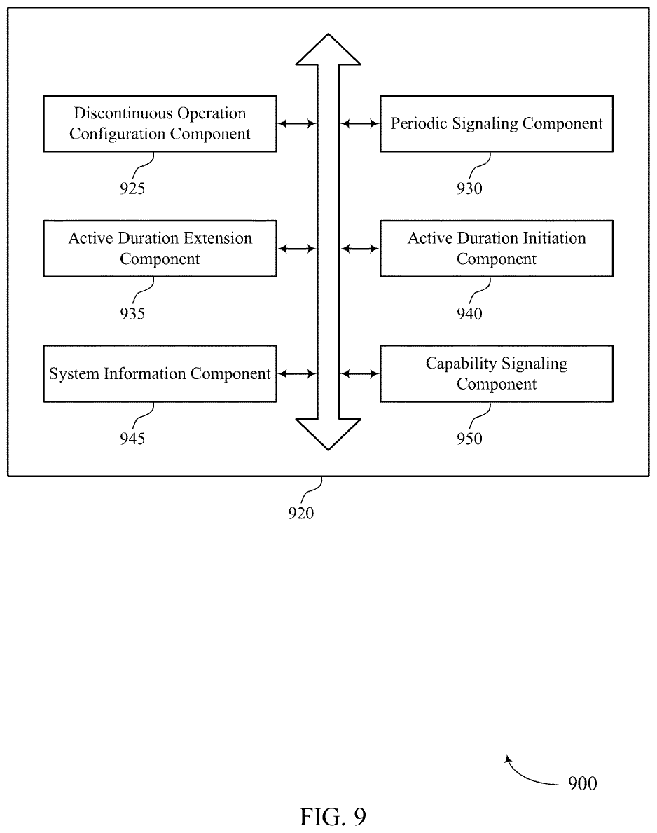

FIG. 9 shows a block diagram 900 of a communications manager 920 that supports extended active time of cellular DTX and DRX in accordance with one or more aspects of the present disclosure. The communications manager 920 may be an example of aspects of a communications manager 720, a communications manager 820, or both, as described herein. The communications manager 920, or various components thereof, may be an example of means for performing various aspects of extended active time of cellular DTX and DRX as described herein. For example, the communications manager 920 may include a discontinuous operation configuration component 925, a periodic signaling component 930, an active duration extension component 935, an active duration initiation component 940, a system information component 945, a capability signaling component 950, or any combination thereof. Each of these components may communicate, directly or indirectly, with one another (e.g., via one or more buses).

The communications manager 920 may support wireless communications at a UE in accordance with examples as disclosed herein. The discontinuous operation configuration component 925 is capable of, configured to, or operable to support a means for receiving a first indication that a network entity in communication with the UE is operating in a discontinuous operation mode, where the discontinuous operation mode is a cell-based DTX mode, a cell-based DRX mode, or both, and where the discontinuous operation mode includes an active duration and an inactive duration that are both within a periodicity. The periodic signaling component 930 is capable of, configured to, or operable to support a means for receiving a second indication that a set of symbols or slots is allocated for SSB reception at the UE for the cell-based DTX mode or for random access transmission at the UE for the cell-based DRX mode, where the set of symbols or slots at least partially overlaps with the inactive duration of the discontinuous operation mode. The active duration extension component 935 is capable of, configured to, or operable to support a means for extending the active duration of the discontinuous operation mode to overlap the set of symbols or slots based on at least one of the set of symbols or slots being within a threshold quantity of symbols or slots from the active duration prior to extension. In some examples, the periodic signaling component 930 is capable of, configured to, or operable to support a means for participating in communications with the network entity during the extended active duration through the SSB reception or the random access transmission.

In some examples, the threshold quantity of symbols or slots is a negative value so that extension of the active duration is based on the set of symbols or slots partially overlapping with the active duration prior to extension.

In some examples, the threshold quantity of symbols or slots is negative one.

In some examples, extending the active duration of the discontinuous operation mode is further based on the set of symbols or slots being located before a start of the active duration prior to extension.

In some examples, extending the active duration of the discontinuous operation mode is further based on the set of symbols or slots being located after an end of the active duration prior to extension.

In some examples, the threshold quantity of symbols or slots is a positive value so that extension of the active duration is based on an edge symbol or slot of the set of symbols or slots being less than the threshold quantity of symbols or slots from a boundary of the active duration prior to extension.

In some examples, the edge symbol or slot is a last symbol or slot of the set of symbols or slots, and the boundary is a beginning of the active duration prior to extension.

In some examples, to support extending the active duration of the discontinuous operation mode, the active duration extension component 935 is capable of, configured to, or operable to support a means for shifting the beginning of the active duration to begin at a first symbol or slot of the set of symbol or slots.

In some examples, the edge symbol or slot is a first symbol or slot of the set of symbols or slots, and the boundary is an ending of the active duration prior to extension.

In some examples, to support extending the active duration of the discontinuous operation mode, the active duration extension component 935 is capable of, configured to, or operable to support a means for shifting the ending of the active duration to end at a last symbol or slot of the set of symbols or slots.

In some examples, the threshold quantity of symbols or slots includes a fixed value, is received via radio resource control signaling, is based on a capability of the UE, or combinations thereof.

In some examples, the threshold quantity of symbols or slots is a first value when extension of the active duration includes a shifting of a beginning of the active duration and a second value when extension of the active duration includes a shifting of an ending of the active duration. In some examples, the first value and the second value are a same value.

In some examples, the threshold quantity of symbols or slots is a first value when extension of the active duration includes a shifting of a beginning of the active duration and a second value when extension of the active duration includes a shifting of an ending of the active duration. In some examples, the first value and the second value are different values.

In some examples, to support receiving the second indication, the system information component 945 is capable of, configured to, or operable to support a means for receiving the second indication in a system information block, where the second indication indicates one or more locations for the SSB reception or the random access transmission at the UE.

In some examples, the capability signaling component 950 is capable of, configured to, or operable to support a means for transmitting a capability indication message indicating a capability of the UE to support extension of the active duration for the SSB reception or for the random access transmission at the UE.

In some examples, the set of symbols or slots is allocated for both the SSB reception and for the random access transmission at the UE, and the active duration extension component 935 is capable of, configured to, or operable to support a means for determining to extend the active duration of the discontinuous operation mode based on one of the SSB reception or the random access transmission.

In some examples, the set of symbols or slots is allocated for both the SSB reception and for the random access transmission at the UE, and the active duration extension component 935 is capable of, configured to, or operable to support a means for determining to extend the active duration of the discontinuous operation mode based on both the SSB reception and the random access transmission.

In some examples, the second indication includes one or more separate configurations or a joint configuration for the SSB reception and for the random access transmission at the UE.

Additionally, or alternatively, the communications manager 920 may support wireless communications at a UE in accordance with examples as disclosed herein. In some examples, the discontinuous operation configuration component 925 is capable of, configured to, or operable to support a means for receive a first indication that a network entity in communication with the UE is operating in a discontinuous operation mode, where the discontinuous operation mode includes a cell-based DRX mode, and where the discontinuous operation mode includes an active duration and an inactive duration that are both within a periodicity. In some examples, the discontinuous operation configuration component 925 is capable of, configured to, or operable to support a means for receive a second indication that one or more symbols or slots are allocated for downlink control channel monitoring by the UE, where the one or more symbols or slots are located within the inactive duration of the discontinuous operation mode. The active duration initiation component 940 is capable of, configured to, or operable to support a means for initiate an active duration of the discontinuous operation mode during the one or more symbols or slots within the inactive duration based on at least one of the one or more symbols or slots being within a threshold quantity of symbols or slots from a set of SSB occasions. In some examples, the periodic signaling component 930 is capable of, configured to, or operable to support a means for participate in communications with the network entity during the initiated active duration through the downlink control channel monitoring.

In some examples, the threshold quantity of symbols or slots is a negative value so that the initiated active duration is based on the one or more slots partially overlapping with the set of SSB occasions.

In some examples, the threshold quantity of symbols or slots is negative one.

In some examples, the one or more symbols or slots are included within the initiated active duration within the inactive duration based on a periodicity of the SSB occasions, a configuration of the cell-based DTX mode, a periodicity of the cell-based DTX mode, the threshold quantity of symbols or slots being overlapping with a set of downlink control channel monitoring occasions, or any combination thereof.

In some examples, the initiated active duration is further based on the one or more symbols or slots being located before a beginning of an active duration of the cell-based DTX mode or after an end of the active duration of the cell-based DTX mode.

In some examples, the threshold quantity of symbols or slots is a positive value so that the initiated active duration is based on an edge symbol or slot of the one or more symbols or slots being less than the threshold quantity of symbols or slots from a boundary of the set of SSB occasions.

In some examples, the downlink control channel monitoring includes one or more downlink control channel occasions located in a UE-specific search space or a common search space set.

In some examples, the initiated active duration occurs within the inactive duration.

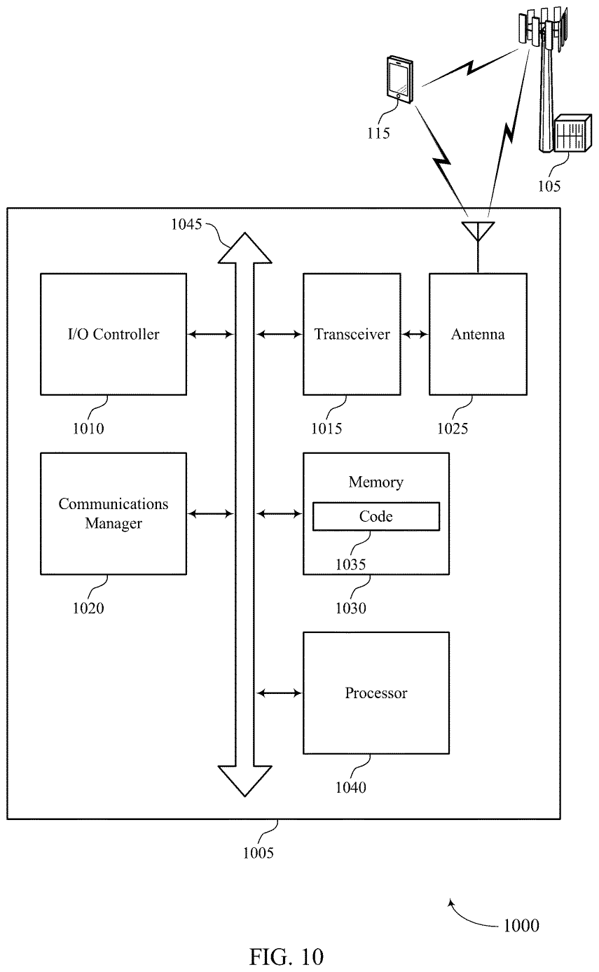

FIG. 10 shows a diagram of a system 1000 including a device 1005 that supports extended active time of cellular DTX and DRX in accordance with one or more aspects of the present disclosure. The device 1005 may be an example of or include the components of a device 705, a device 805, or a UE 115 as described herein. The device 1005 may communicate (e.g., wirelessly) with one or more network entities 105, one or more UEs 115, or any combination thereof. The device 1005 may include components for bi-directional voice and data communications including components for transmitting and receiving communications, such as a communications manager 1020, an input/output (I/O) controller 1010, a transceiver 1015, an antenna 1025, a memory 1030, code 1035, and a processor 1040. These components may be in electronic communication or otherwise coupled (e.g., operatively, communicatively, functionally, electronically, electrically) via one or more buses (e.g., a bus 1045).

The I/O controller 1010 may manage input and output signals for the device 1005. The I/O controller 1010 may also manage peripherals not integrated into the device 1005. In some cases, the I/O controller 1010 may represent a physical connection or port to an external peripheral. In some cases, the I/O controller 1010 may utilize an operating system such as iOS®, ANDROID®, MS-DOS®, MS-WINDOWS®, OS/2®, UNIX®, LINUX®, or another known operating system. Additionally or alternatively, the I/O controller 1010 may represent or interact with a modem, a keyboard, a mouse, a touchscreen, or a similar device. In some cases, the I/O controller 1010 may be implemented as part of a processor, such as the processor 1040. In some cases, a user may interact with the device 1005 via the I/O controller 1010 or via hardware components controlled by the I/O controller 1010.

In some cases, the device 1005 may include a single antenna 1025. However, in some other cases, the device 1005 may have more than one antenna 1025, which may be capable of concurrently transmitting or receiving multiple wireless transmissions. The transceiver 1015 may communicate bi-directionally, via the one or more antennas 1025, wired, or wireless links as described herein. For example, the transceiver 1015 may represent a wireless transceiver and may communicate bi-directionally with another wireless transceiver. The transceiver 1015 may also include a modem to modulate the packets, to provide the modulated packets to one or more antennas 1025 for transmission, and to demodulate packets received from the one or more antennas 1025. The transceiver 1015, or the transceiver 1015 and one or more antennas 1025, may be an example of a transmitter 715, a transmitter 815, a receiver 710, a receiver 810, or any combination thereof or component thereof, as described herein.

The memory 1030 may include random access memory (RAM) and read-only memory (ROM). The memory 1030 may store computer-readable, computer-executable code 1035 including instructions that, when executed by the processor 1040, cause the device 1005 to perform various functions described herein. The code 1035 may be stored in a non-transitory computer-readable medium such as system memory or another type of memory. In some cases, the code 1035 may not be directly executable by the processor 1040 but may cause a computer (e.g., when compiled and executed) to perform functions described herein. In some cases, the memory 1030 may contain, among other things, a basic I/O system (BIOS) which may control basic hardware or software operation such as the interaction with peripheral components or devices.

The processor 1040 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1040 may be configured to operate a memory array using a memory controller. In some other cases, a memory controller may be integrated into the processor 1040. The processor 1040 may be configured to execute computer-readable instructions stored in a memory (e.g., the memory 1030) to cause the device 1005 to perform various functions (e.g., functions or tasks supporting extended active time of cellular DTX and DRX). For example, the device 1005 or a component of the device 1005 may include a processor 1040 and memory 1030 coupled with or to the processor 1040, the processor 1040 and memory 1030 configured to perform various functions described herein.

The communications manager 1020 may support wireless communications at a UE in accordance with examples as disclosed herein. For example, the communications manager 1020 is capable of, configured to, or operable to support a means for receiving a first indication that a network entity in communication with the UE is operating in a discontinuous operation mode, where the discontinuous operation mode is a cell-based DTX mode, a cell-based DRX mode, or both, and where the discontinuous operation mode includes an active duration and an inactive duration that are both within a periodicity. The communications manager 1020 is capable of, configured to, or operable to support a means for receiving a second indication that a set of symbols or slots is allocated for SSB reception at the UE for the cell-based DTX mode or for random access transmission at the UE for the cell-based DRX mode, where the set of symbols or slots at least partially overlaps with the inactive duration of the discontinuous operation mode. The communications manager 1020 is capable of, configured to, or operable to support a means for extending the active duration of the discontinuous operation mode to overlap the set of symbols or slots based on at least one of the set of symbols or slots being within a threshold quantity of symbols or slots from the active duration prior to extension. The communications manager 1020 is capable of, configured to, or operable to support a means for participating in communications with the network entity during the extended active duration through the SSB reception or the random access transmission.

Additionally, or alternatively, the communications manager 1020 may support wireless communications at a UE in accordance with examples as disclosed herein. For example, the communications manager 1020 is capable of, configured to, or operable to support a means for receiving a first indication that a network entity in communication with the UE is operating in a discontinuous operation mode, where the discontinuous operation mode includes a cell-based DTX mode, and where the discontinuous operation mode includes an active duration and an inactive duration that are both within a periodicity. The communications manager 1020 is capable of, configured to, or operable to support a means for receiving a second indication that one or more symbols or slots are allocated for downlink control channel monitoring by the UE, where the one or more symbols or slots are located within the inactive duration of the discontinuous operation mode. The communications manager 1020 is capable of, configured to, or operable to support a means for initiating an active duration of the discontinuous operation mode during the one or more symbols or slots within the inactive duration based on at least one of the one or more symbols or slots being within a threshold quantity of symbols or slots from a set of SSB occasions. The communications manager 1020 is capable of, configured to, or operable to support a means for participating in communications with the network entity during the initiated active duration through the downlink control channel monitoring.

By including or configuring the communications manager 1020 in accordance with examples as described herein, the device 1005 may support techniques for improved communication reliability, reduced latency, improved user experience related to reduced processing, reduced power consumption, more efficient utilization of communication resources, improved coordination between devices, longer battery life, improved utilization of processing capability, increased communication and scheduling efficiency for periodic signaling and for DRX and DTX communications, and reduced network-side power expenditure.

In some examples, the communications manager 1020 may be configured to perform various operations (e.g., receiving, monitoring, transmitting) using or otherwise in cooperation with the transceiver 1015, the one or more antennas 1025, or any combination thereof. Although the communications manager 1020 is illustrated as a separate component, in some examples, one or more functions described with reference to the communications manager 1020 may be supported by or performed by the processor 1040, the memory 1030, the code 1035, or any combination thereof. For example, the code 1035 may include instructions executable by the processor 1040 to cause the device 1005 to perform various aspects of extended active time of cellular DTX and DRX as described herein, or the processor 1040 and the memory 1030 may be otherwise configured to perform or support such operations.

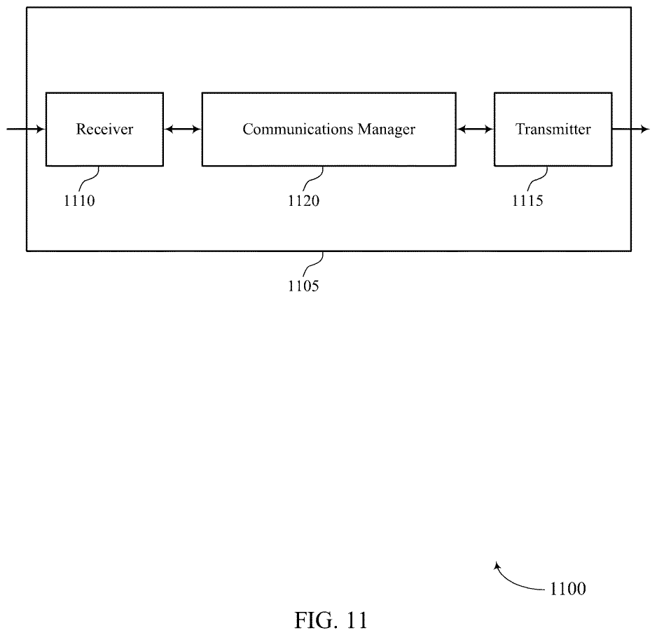

FIG. 11 shows a block diagram 1100 of a device 1105 that supports extended active time of cellular DTX and DRX in accordance with one or more aspects of the present disclosure. The device 1105 may be an example of aspects of a network entity 105 as described herein. The device 1105 may include a receiver 1110, a transmitter 1115, and a communications manager 1120. The device 1105 may also include a processor. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The communications manager 1120, the receiver 1110, the transmitter 1115, or various combinations thereof or various components thereof may be examples of means for performing various aspects of extended active time of cellular DTX and DRX as described herein. For example, the communications manager 1120, the receiver 1110, the transmitter 1115, or various combinations or components thereof may support a method for performing one or more of the functions described herein.

In some examples, the communications manager 1120, the receiver 1110, the transmitter 1115, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1120, the receiver 1110, the transmitter 1115, or various combinations or components thereof may be implemented in code (e.g., as communications management software or firmware) executed by a processor. If implemented in code executed by a processor, the functions of the communications manager 1120, the receiver 1110, the transmitter 1115, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 1120 may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communications at a network entity in accordance with examples as disclosed herein. For example, the communications manager 1120 is capable of, configured to, or operable to support a means for operating in a discontinuous operation mode, where the discontinuous operation mode is a cell-based DTX mode, a cell-based DRX mode, or both, and where the discontinuous operation mode includes an active duration and an inactive duration that are both within a periodicity. The communications manager 1120 is capable of, configured to, or operable to support a means for allocating a set of symbols or slots for SSB transmission at the network entity for the cell-based DTX mode or for random access reception at the network entity for the cell-based DRX mode, where the set of symbols or slots at least partially overlaps with the inactive duration of the discontinuous operation mode. The communications manager 1120 is capable of, configured to, or operable to support a means for extending the active duration of the discontinuous operation mode to overlap the set of symbols or slots based on at least one of the set of symbols or slots being within a threshold quantity of symbols or slots from the active duration prior to extension. The communications manager 1120 is capable of, configured to, or operable to support a means for participating in communications with a UE during the extended active duration through the SSB transmission or the random access reception.

Additionally, or alternatively, the communications manager 1120 may support wireless communications at a network entity in accordance with examples as disclosed herein. For example, the communications manager 1120 is capable of, configured to, or operable to support a means for operating in a discontinuous operation mode, where the discontinuous operation mode is a cell-based DTX mode, and where the discontinuous operation mode includes an active duration and an inactive duration that are both within a periodicity. The communications manager 1120 is capable of, configured to, or operable to support a means for allocating one or more symbols or slots for downlink control channel transmission at the network entity, where the set of symbols or slots are located within the inactive duration of the discontinuous operation mode. The communications manager 1120 is capable of, configured to, or operable to support a means for initiating an active duration of the discontinuous operation mode during the one or more symbols or slots within the inactive duration based on at least one of the set of symbols or slots being within a threshold quantity of symbols or slots from a set of SSB occasions. The communications manager 1120 is capable of, configured to, or operable to support a means for participating in communications with a UE during the initiated active duration through the downlink control channel transmission.

By including or configuring the communications manager 1120 in accordance with examples as described herein, the device 1105 (e.g., a processor controlling or otherwise coupled with the receiver 1110, the transmitter 1115, the communications manager 1120, or a combination thereof) may support techniques for reduced processing, reduced power consumption, more efficient utilization of communication resources, and more efficient handling of DRX and DTX communications.

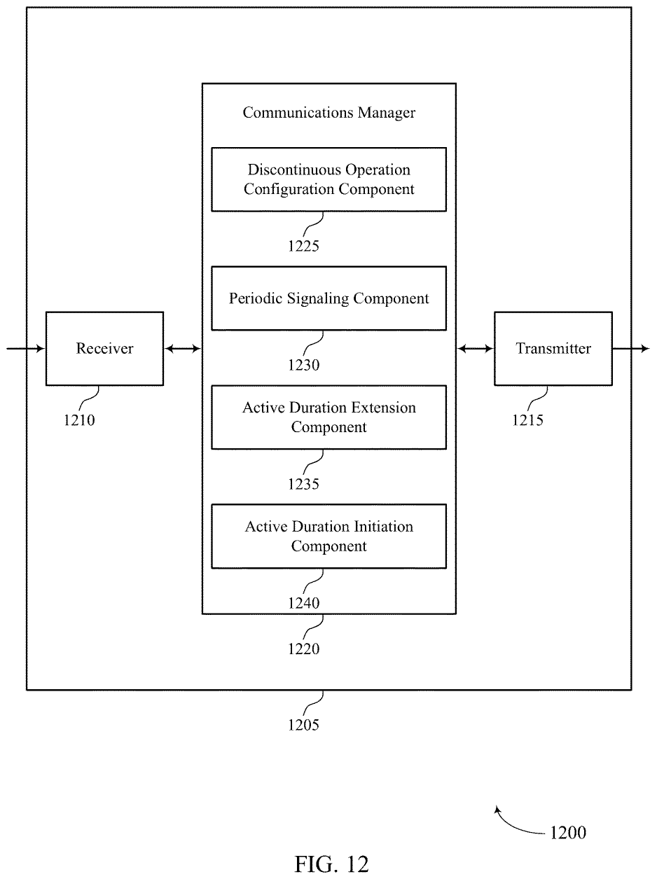

FIG. 12 shows a block diagram 1200 of a device 1205 that supports extended active time of cellular DTX and DRX in accordance with one or more aspects of the present disclosure. The device 1205 may be an example of aspects of a device 1105 or a network entity 105 as described herein. The device 1205 may include a receiver 1210, a transmitter 1215, and a communications manager 1220. The device 1205 may also include a processor. Each of these components may be in communication with one another (e.g., via one or more buses).

The receiver 1210 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1205. In some examples, the receiver 1210 may support obtaining information by receiving signals via one or more antennas. Additionally, or alternatively, the receiver 1210 may support obtaining information by receiving signals via one or more wired (e.g., electrical, fiber optic) interfaces, wireless interfaces, or any combination thereof.

The transmitter 1215 may provide a means for outputting (e.g., transmitting, providing, conveying, sending) information generated by other components of the device 1205. For example, the transmitter 1215 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1215 may support outputting information by transmitting signals via one or more antennas. Additionally, or alternatively, the transmitter 1215 may support outputting information by transmitting signals via one or more wired (e.g., electrical, fiber optic) interfaces, wireless interfaces, or any combination thereof. In some examples, the transmitter 1215 and the receiver 1210 may be co-located in a transceiver, which may include or be coupled with a modem.

The device 1205, or various components thereof, may be an example of means for performing various aspects of extended active time of cellular DTX and DRX as described herein. For example, the communications manager 1220 may include a discontinuous operation configuration component 1225, a periodic signaling component 1230, an active duration extension component 1235, an active duration initiation component 1240, or any combination thereof. The communications manager 1220 may be an example of aspects of a communications manager 1120 as described herein. In some examples, the communications manager 1220, or various components thereof, may be configured to perform various operations (e.g., receiving, obtaining, monitoring, outputting, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to obtain information, output information, or perform various other operations as described herein.

The communications manager 1220 may support wireless communications at a network entity in accordance with examples as disclosed herein. The discontinuous operation configuration component 1225 is capable of, configured to, or operable to support a means for operating in a discontinuous operation mode, where the discontinuous operation mode is a cell-based DTX mode, a cell-based DRX mode, or both, and where the discontinuous operation mode includes an active duration and an inactive duration that are both within a periodicity. The periodic signaling component 1230 is capable of, configured to, or operable to support a means for allocating a set of symbols or slots for SSB transmission at the network entity for the cell-based DTX mode or for random access reception at the network entity for the cell-based DRX mode, where the set of symbols or slots at least partially overlaps with the inactive duration of the discontinuous operation mode. The active duration extension component 1235 is capable of, configured to, or operable to support a means for extending the active duration of the discontinuous operation mode to overlap the set of symbols or slots based on at least one of the set of symbols or slots being within a threshold quantity of symbols or slots from the active duration prior to extension. The periodic signaling component 1230 is capable of, configured to, or operable to support a means for participating in communications with a UE during the extended active duration through the SSB transmission or the random access reception.

Additionally, or alternatively, the communications manager 1220 may support wireless communications at a network entity in accordance with examples as disclosed herein. The discontinuous operation configuration component 1225 is capable of, configured to, or operable to support a means for operating in a discontinuous operation mode, where the discontinuous operation mode is a cell-based DTX mode, and where the discontinuous operation mode includes an active duration and an inactive duration that are both within a periodicity. The discontinuous operation configuration component 1225 is capable of, configured to, or operable to support a means for allocating one or more symbols or slots for downlink control channel transmission at the network entity, where the set of symbols or slots are located within the inactive duration of the discontinuous operation mode. The active duration initiation component 1240 is capable of, configured to, or operable to support a means for initiating an active duration of the discontinuous operation mode during the one or more symbols or slots within the inactive duration based on at least one of the set of symbols or slots being within a threshold quantity of symbols or slots from a set of SSB occasions. The periodic signaling component 1230 is capable of, configured to, or operable to support a means for participate in communications with a UE during the initiated active duration through the downlink control channel transmission.

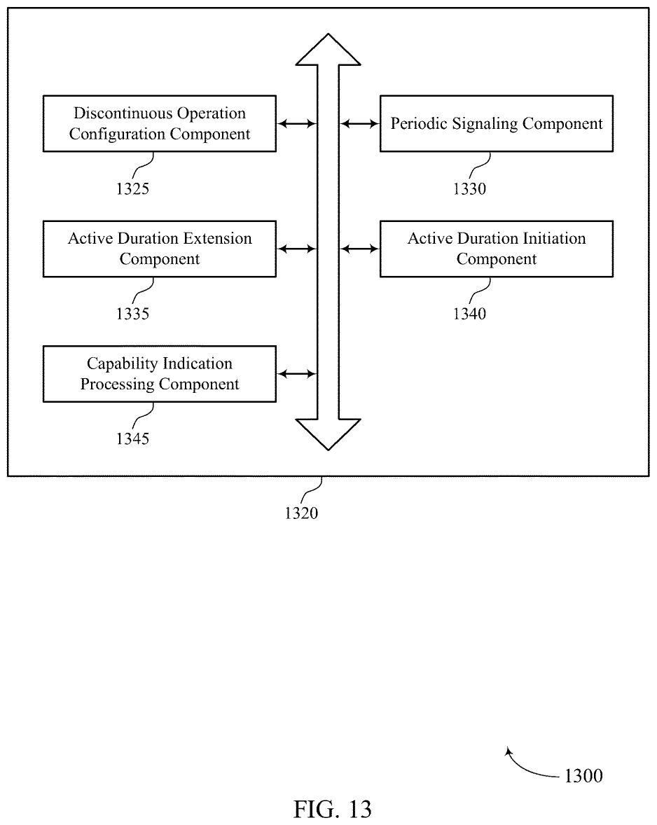

FIG. 13 shows a block diagram 1300 of a communications manager 1320 that supports extended active time of cellular DTX and DRX in accordance with one or more aspects of the present disclosure. The communications manager 1320 may be an example of aspects of a communications manager 1120, a communications manager 1220, or both, as described herein. The communications manager 1320, or various components thereof, may be an example of means for performing various aspects of extended active time of cellular DTX and DRX as described herein. For example, the communications manager 1320 may include a discontinuous operation configuration component 1325, a periodic signaling component 1330, an active duration extension component 1335, an active duration initiation component 1340, a capability indication processing component 1345, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1320 may support wireless communications at a network entity in accordance with examples as disclosed herein. The discontinuous operation configuration component 1325 is capable of, configured to, or operable to support a means for operating in a discontinuous operation mode, where the discontinuous operation mode is a cell-based DTX mode, a cell-based DRX mode, or both, and where the discontinuous operation mode includes an active duration and an inactive duration that are both within a periodicity. The periodic signaling component 1330 is capable of, configured to, or operable to support a means for allocating a set of symbols or slots for SSB transmission at the network entity for the cell-based DTX mode or for random access reception at the network entity for the cell-based DRX mode, where the set of symbols or slots at least partially overlaps with the inactive duration of the discontinuous operation mode. The active duration extension component 1335 is capable of, configured to, or operable to support a means for extending the active duration of the discontinuous operation mode to overlap the set of symbols or slots based on at least one of the set of symbols or slots being within a threshold quantity of symbols or slots from the active duration prior to extension. In some examples, the periodic signaling component 1330 is capable of, configured to, or operable to support a means for participating in communications with a UE during the extended active duration through the SSB transmission or the random access reception.

In some examples, the threshold quantity of symbols or slots is a negative value so that extension of the active duration is based on the set of symbols or slots partially overlapping with the active duration prior to extension.

In some examples, the threshold quantity of symbols or slots is negative one.

In some examples, extending the active duration of the discontinuous operation mode is further based on the set of symbols or slots being located before a start of the active duration prior to extension.

In some examples, extending the active duration of the discontinuous operation mode is further based on the set of symbols or slots being located after an end of the active duration prior to extension.

In some examples, the threshold quantity of symbols or slots is a positive value so that extension of the active duration is based on an edge symbol or slot of the set of symbols or slots being less than the threshold quantity of symbols or slots from a boundary of the active duration prior to extension.

In some examples, the edge symbol or slot is a last symbol or slot of the set of symbols or slots, and the boundary is a beginning of the active duration prior to extension.

In some examples, to support extending the active duration of the discontinuous operation mode, the active duration extension component 1335 is capable of, configured to, or operable to support a means for shifting the beginning of the active duration to begin at a first symbols or slot of the set of symbols or slots.

In some examples, the edge symbol or slot is a first symbol or slot of the set of symbols or slots, and the boundary is an ending of the active duration prior to extension.

In some examples, to support extending the active duration of the discontinuous operation mode, the active duration extension component 1335 is capable of, configured to, or operable to support a means for shifting the ending of the active duration to end at a last symbol or slot of the set of symbols or slots.

In some examples, the threshold quantity of symbols or slots includes a fixed value, is transmitted via radio resource control signaling, is based on a capability of the UE, or combinations thereof.

In some examples, the threshold quantity of symbols or slots is a first value when extension of the active duration includes a shifting of a beginning of the active duration and a second value when extension of the active duration includes a shifting of an ending of the active duration. In some examples, the first value and the second value are a same value.

In some examples, the threshold quantity of symbols or slots is a first value when extension of the active duration includes a shifting of a beginning of the active duration and a second value when extension of the active duration includes a shifting of an ending of the active duration. In some examples, the first value and the second value are different values.

In some examples, the capability indication processing component 1345 is capable of, configured to, or operable to support a means for receiving a capability indication message indicating a capability of the UE to support extension of the active duration.

In some examples, the set of symbols or slots is allocated for both the SSB transmission and for the random access reception at the UE, and the active duration extension component 1335 is capable of, configured to, or operable to support a means for extending the active duration of the discontinuous operation mode based on one of the SSB transmission or the random access reception.

In some examples, the set of symbols or slots is allocated for both the SSB transmission and for the random access reception at the UE, and the active duration extension component 1335 is capable of, configured to, or operable to support a means for extending the active duration of the discontinuous operation mode based on both the SSB transmission and the random access reception.

In some examples, the set of symbols or slots are allocated via one or more separate configurations or a joint configuration for the SSB transmission and for the random access reception.

Additionally, or alternatively, the communications manager 1320 may support wireless communications at a network entity in accordance with examples as disclosed herein. In some examples, the discontinuous operation configuration component 1325 is capable of, configured to, or operable to support a means for operating in a discontinuous operation mode, where the discontinuous operation mode is a cell-based DTX mode, and where the discontinuous operation mode includes an active duration and an inactive duration that are both within a periodicity. In some examples, the discontinuous operation configuration component 1325 is capable of, configured to, or operable to support a means for allocating one or more symbols or slots for downlink control channel transmission at the network entity, where the set of symbols or slots are located within the inactive duration of the discontinuous operation mode. The active duration initiation component 1340 is capable of, configured to, or operable to support a means for initiating an active duration of the discontinuous operation mode during the one or more symbols or slots within the inactive duration based on at least one of the set of symbols or slots being within a threshold quantity of symbols or slots from a set of SSB occasions. In some examples, the periodic signaling component 1330 is capable of, configured to, or operable to support a means for participate in communications with a UE during the initiated active duration through the downlink control channel transmission.

In some examples, the threshold quantity of symbols or slots is a negative value so that the initiated active duration is based on the one or more symbols or slots partially overlapping with the set of SSB occasions.

In some examples, the threshold quantity of symbols or slots is negative one.

In some examples, the one or more symbols or slots are included within the initiated active duration within the inactive duration based on a periodicity of the SSB occasions, a configuration of the cell-based DTX mode, a periodicity of the cell-based DTX mode, the threshold quantity of symbols or slots being overlapping with a set of downlink control channel monitoring occasions, or any combination thereof.

In some examples, the initiated active duration is further based on the one or more symbols or slots being located before a beginning of an active duration of the cell-based DTX mode or after an end of the active duration of the cell-based DTX mode.

In some examples, the threshold quantity of symbols or slots is a positive value so that the initiated active duration is based on an edge symbol or slot of the one or more symbols or slots being less than the threshold quantity of symbols or slots from a boundary of the set of SSB occasions.

In some examples, the downlink control channel monitoring for SSB transmission includes one or more downlink control channel occasions located in a UE-specific search space or a common search space set.

In some examples, the initiated active duration occurs within the inactive duration.

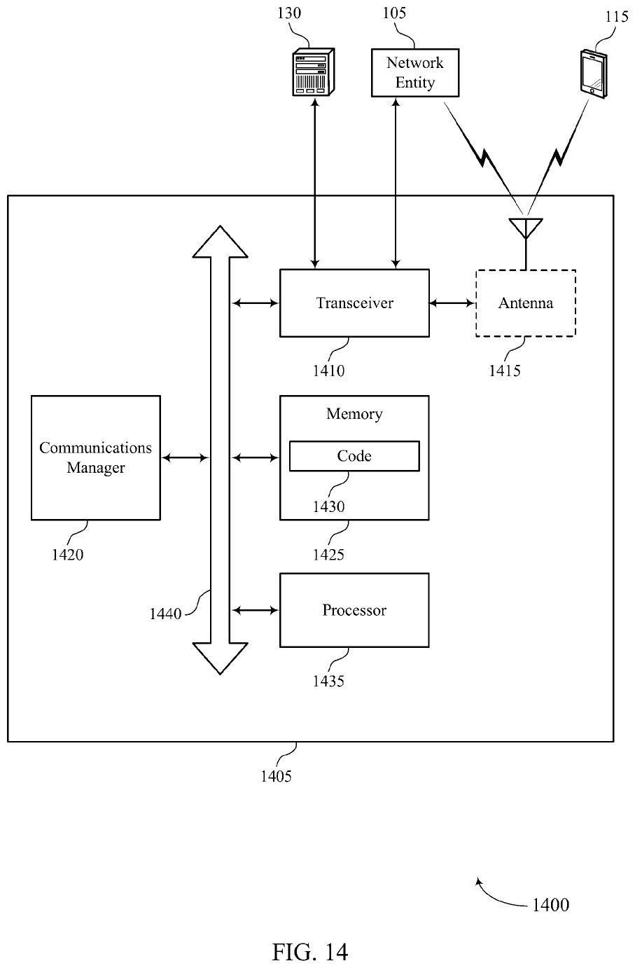

FIG. 14 shows a diagram of a system 1400 including a device 1405 that supports extended active time of cellular DTX and DRX in accordance with one or more aspects of the present disclosure. The device 1405 may be an example of or include the components of a device 1105, a device 1205, or a network entity 105 as described herein. The device 1405 may communicate with one or more network entities 105, one or more UEs 115, or any combination thereof, which may include communications over one or more wired interfaces, over one or more wireless interfaces, or any combination thereof. The device 1405 may include components that support outputting and obtaining communications, such as a communications manager 1420, a transceiver 1410, an antenna 1415, a memory 1425, code 1430, and a processor 1435. These components may be in electronic communication or otherwise coupled (e.g., operatively, communicatively, functionally, electronically, electrically) via one or more buses (e.g., a bus 1440).

The transceiver 1410 may support bi-directional communications via wired links, wireless links, or both as described herein. In some examples, the transceiver 1410 may include a wired transceiver and may communicate bi-directionally with another wired transceiver. Additionally, or alternatively, in some examples, the transceiver 1410 may include a wireless transceiver and may communicate bi-directionally with another wireless transceiver. In some examples, the device 1405 may include one or more antennas 1415, which may be capable of transmitting or receiving wireless transmissions (e.g., concurrently). The transceiver 1410 may also include a modem to modulate signals, to provide the modulated signals for transmission (e.g., by one or more antennas 1415, by a wired transmitter), to receive modulated signals (e.g., from one or more antennas 1415, from a wired receiver), and to demodulate signals. In some implementations, the transceiver 1410 may include one or more interfaces, such as one or more interfaces coupled with the one or more antennas 1415 that are configured to support various receiving or obtaining operations, or one or more interfaces coupled with the one or more antennas 1415 that are configured to support various transmitting or outputting operations, or a combination thereof. In some implementations, the transceiver 1410 may include or be configured for coupling with one or more processors or memory components that are operable to perform or support operations based on received or obtained information or signals, or to generate information or other signals for transmission or other outputting, or any combination thereof. In some implementations, the transceiver 1410, or the transceiver 1410 and the one or more antennas 1415, or the transceiver 1410 and the one or more antennas 1415 and one or more processors or memory components (for example, the processor 1435, or the memory 1425, or both), may be included in a chip or chip assembly that is installed in the device 1405. In some examples, the transceiver may be operable to support communications via one or more communications links (e.g., a communication link 125, a backhaul communication link 120, a midhaul communication link 162, a fronthaul communication link 168).

The memory 1425 may include RAM and ROM. The memory 1425 may store computer-readable, computer-executable code 1430 including instructions that, when executed by the processor 1435, cause the device 1405 to perform various functions described herein. The code 1430 may be stored in a non-transitory computer-readable medium such as system memory or another type of memory. In some cases, the code 1430 may not be directly executable by the processor 1435 but may cause a computer (e.g., when compiled and executed) to perform functions described herein. In some cases, the memory 1425 may contain, among other things, a BIOS which may control basic hardware or software operation such as the interaction with peripheral components or devices.

The processor 1435 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1435 may be configured to operate a memory array using a memory controller. In some other cases, a memory controller may be integrated into the processor 1435. The processor 1435 may be configured to execute computer-readable instructions stored in a memory (e.g., the memory 1425) to cause the device 1405 to perform various functions (e.g., functions or tasks supporting extended active time of cellular DTX and DRX). For example, the device 1405 or a component of the device 1405 may include a processor 1435 and memory 1425 coupled with the processor 1435, the processor 1435 and memory 1425 configured to perform various functions described herein. The processor 1435 may be an example of a cloud-computing platform (e.g., one or more physical nodes and supporting software such as operating systems, virtual machines, or container instances) that may host the functions (e.g., by executing code 1430) to perform the functions of the device 1405. The processor 1435 may be any one or more suitable processors capable of executing scripts or instructions of one or more software programs stored in the device 1405 (such as within the memory 1425). In some implementations, the processor 1435 may be a component of a processing system. A processing system may generally refer to a system or series of machines or components that receives inputs and processes the inputs to produce a set of outputs (which may be passed to other systems or components of, for example, the device 1405). For example, a processing system of the device 1405 may refer to a system including the various other components or subcomponents of the device 1405, such as the processor 1435, or the transceiver 1410, or the communications manager 1420, or other components or combinations of components of the device 1405. The processing system of the device 1405 may interface with other components of the device 1405, and may process information received from other components (such as inputs or signals) or output information to other components. For example, a chip or modem of the device 1405 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1405 may transmit information output from the chip or modem. Additionally, or alternatively, in some implementations, the one or more interfaces may refer to an interface between the processing system of the chip or modem and a receiver, such that the device 1405 may obtain information or signal inputs, and the information may be passed to the processing system. A person having ordinary skill in the art will readily recognize that a first interface also may obtain information or signal inputs, and a second interface also may output information or signal outputs.

In some examples, a bus 1440 may support communications of (e.g., within) a protocol layer of a protocol stack. In some examples, a bus 1440 may support communications associated with a logical channel of a protocol stack (e.g., between protocol layers of a protocol stack), which may include communications performed within a component of the device 1405, or between different components of the device 1405 that may be co-located or located in different locations (e.g., where the device 1405 may refer to a system in which one or more of the communications manager 1420, the transceiver 1410, the memory 1425, the code 1430, and the processor 1435 may be located in one of the different components or divided between different components).

In some examples, the communications manager 1420 may manage aspects of communications with a core network 130 (e.g., via one or more wired or wireless backhaul links). For example, the communications manager 1420 may manage the transfer of data communications for client devices, such as one or more UEs 115. In some examples, the communications manager 1420 may manage communications with other network entities 105, and may include a controller or scheduler for controlling communications with UEs 115 in cooperation with other network entities 105. In some examples, the communications manager 1420 may support an X2 interface within an LTE/LTE-A wireless communications network technology to provide communication between network entities 105.

The communications manager 1420 may support wireless communications at a network entity in accordance with examples as disclosed herein. For example, the communications manager 1420 is capable of, configured to, or operable to support a means for operating in a discontinuous operation mode, where the discontinuous operation mode is a cell-based DTX mode, a cell-based DRX mode, or both, and where the discontinuous operation mode includes an active duration and an inactive duration that are both within a periodicity. The communications manager 1420 is capable of, configured to, or operable to support a means for allocating a set of symbols or slots for SSB transmission at the network entity for the cell-based DRX mode or for random access reception at the network entity for the cell-based DRX mode, where the set of symbols or slots at least partially overlaps with the inactive duration of the discontinuous operation mode. The communications manager 1420 is capable of, configured to, or operable to support a means for extending the active duration of the discontinuous operation mode to overlap the set of symbols or slots based on at least one of the set of symbols or slots being within a threshold quantity of symbols or slots from the active duration prior to extension. The communications manager 1420 is capable of, configured to, or operable to support a means for participating in communications with a UE during the extended active duration through the SSB transmission or the random access reception.

Additionally, or alternatively, the communications manager 1420 may support wireless communications at a network entity in accordance with examples as disclosed herein. For example, the communications manager 1420 is capable of, configured to, or operable to support a means for operating in a discontinuous operation mode, where the discontinuous operation mode is a cell-based DTX mode, and where the discontinuous operation mode includes an active duration and an inactive duration that are both within a periodicity. The communications manager 1420 is capable of, configured to, or operable to support a means for allocating one or more symbols or slots for downlink control channel transmission at the network entity, where the set of symbols or slots are located within the inactive duration of the discontinuous operation mode. The communications manager 1420 is capable of, configured to, or operable to support a means for initiating an active duration of the discontinuous operation mode during the one or more symbols or slots within the inactive duration based on at least one of the set of symbols or slots being within a threshold quantity of symbols or slots from a set of SSB occasions. The communications manager 1420 is capable of, configured to, or operable to support a means for participating in communications with a UE during the initiated active duration through the downlink control channel transmission.

By including or configuring the communications manager 1420 in accordance with examples as described herein, the device 1405 may support techniques for improved communication reliability, reduced latency, improved user experience related to reduced processing, reduced power consumption, more efficient utilization of communication resources, improved coordination between devices, longer battery life, improved utilization of processing capability, increased communication and scheduling efficiency for periodic signaling and for DRX and DTX communications, and reduced network-side power expenditure.

In some examples, the communications manager 1420 may be configured to perform various operations (e.g., receiving, obtaining, monitoring, outputting, transmitting) using or otherwise in cooperation with the transceiver 1410, the one or more antennas 1415 (e.g., where applicable), or any combination thereof. Although the communications manager 1420 is illustrated as a separate component, in some examples, one or more functions described with reference to the communications manager 1420 may be supported by or performed by the transceiver 1410, the processor 1435, the memory 1425, the code 1430, or any combination thereof. For example, the code 1430 may include instructions executable by the processor 1435 to cause the device 1405 to perform various aspects of extended active time of cellular DTX and DRX as described herein, or the processor 1435 and the memory 1425 may be otherwise configured to perform or support such operations.

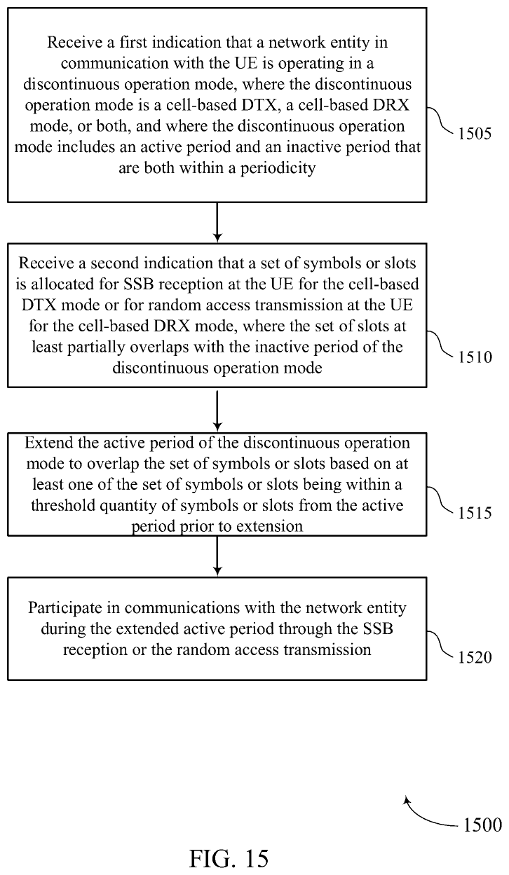

FIG. 15 shows a flowchart illustrating a method 1500 that supports extended active time of cellular DTX and DRX in accordance with aspects of the present disclosure. The operations of the method 1500 may be implemented by a UE or its components as described herein. For example, the operations of the method 1500 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1505, the method may include receiving a first indication that a network entity in communication with the UE is operating in a discontinuous operation mode, where the discontinuous operation mode is a cell-based DTX mode, a cell-based DRX mode, or both, and where the discontinuous operation mode includes an active duration and an inactive duration that are both within a periodicity. The operations of block 1505 may be performed in accordance with examples as disclosed herein. In some examples, aspects of the operations of 1505 may be performed by a discontinuous operation configuration component 925 as described with reference to FIG. 9.

At 1510, the method may include receiving a second indication that a set of symbols or slots is allocated for SSB reception at the UE for the cell-based DTX mode or for random access transmission at the UE for the cell-based DRX mode, where the set of symbols or slots at least partially overlaps with the inactive duration of the discontinuous operation mode. The operations of block 1510 may be performed in accordance with examples as disclosed herein. In some examples, aspects of the operations of 1510 may be performed by a periodic signaling component 930 as described with reference to FIG. 9.

At 1515, the method may include extending the active duration of the discontinuous operation mode to overlap the set of symbols or slots based on at least one of the set of symbols or slots being within a threshold quantity of symbols or slots from the active duration prior to extension. The operations of block 1515 may be performed in accordance with examples as disclosed herein. In some examples, aspects of the operations of 1515 may be performed by an active duration extension component 935 as described with reference to FIG. 9.

At 1520, the method may include participating in communications with the network entity during the extended active duration through the SSB reception or the random access transmission. The operations of block 1520 may be performed in accordance with examples as disclosed herein. In some examples, aspects of the operations of 1520 may be performed by a periodic signaling component 930 as described with reference to FIG. 9.

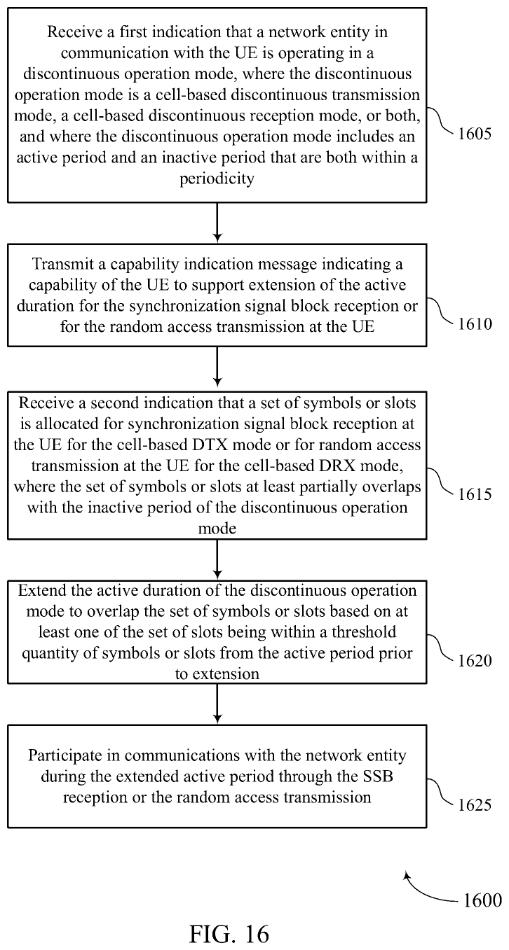

FIG. 16 shows a flowchart illustrating a method 1600 that supports extended active time of cellular DTX and DRX in accordance with aspects of the present disclosure. The operations of the method 1600 may be implemented by a UE or its components as described herein. For example, the operations of the method 1600 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1605, the method may include receiving a first indication that a network entity in communication with the UE is operating in a discontinuous operation mode, where the discontinuous operation mode is a cell-based DTX mode, a cell-based DRX mode, or both, and where the discontinuous operation mode includes an active duration and an inactive duration that are both within a periodicity. The operations of block 1605 may be performed in accordance with examples as disclosed herein. In some examples, aspects of the operations of 1605 may be performed by a discontinuous operation configuration component 925 as described with reference to FIG. 9.

At 1610, the method may include transmitting a capability indication message indicating a capability of the UE to support extension of the active duration for the SSB reception or for the random access transmission at the UE. The operations of block 1610 may be performed in accordance with examples as disclosed herein. In some examples, aspects of the operations of 1610 may be performed by a capability signaling component 950 as described with reference to FIG. 9.

At 1615, the method may include receiving a second indication that a set of symbols or slots is allocated for SSB reception at the UE for the cell-based DTX mode or for random access transmission at the UE for the cell-based DRX mode, where the set of symbols or slots at least partially overlaps with the inactive duration of the discontinuous operation mode. The operations of block 1615 may be performed in accordance with examples as disclosed herein. In some examples, aspects of the operations of 1615 may be performed by a periodic signaling component 930 as described with reference to FIG. 9.

At 1620, the method may include extending the active duration of the discontinuous operation mode to overlap the set of symbols or slots based on at least one of the set of symbols or slots being within a threshold quantity of symbols or slots from the active duration prior to extension. The operations of block 1620 may be performed in accordance with examples as disclosed herein. In some examples, aspects of the operations of 1620 may be performed by an active duration extension component 935 as described with reference to FIG. 9.

At 1625, the method may include participating in communications with the network entity during the extended active duration through the SSB reception or the random access transmission. The operations of block 1625 may be performed in accordance with examples as disclosed herein. In some examples, aspects of the operations of 1625 may be performed by a periodic signaling component 930 as described with reference to FIG. 9.

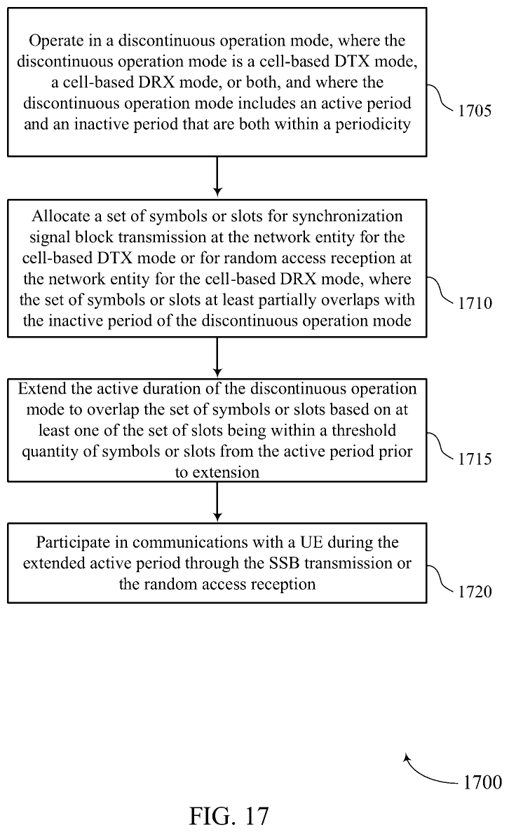

FIG. 17 shows a flowchart illustrating a method 1700 that supports extended active time of cellular DTX and DRX in accordance with aspects of the present disclosure. The operations of the method 1700 may be implemented by a network entity or its components as described herein. For example, the operations of the method 1700 may be performed by a network entity as described with reference to FIGS. 1 through 6 and 11 through 14. In some examples, a network entity may execute a set of instructions to control the functional elements of the network entity to perform the described functions. Additionally, or alternatively, the network entity may perform aspects of the described functions using special-purpose hardware.

At 1705, the method may include operating in a discontinuous operation mode, where the discontinuous operation mode is a cell-based DTX mode, a cell-based DRX mode, or both, and where the discontinuous operation mode includes an active duration and an inactive duration that are both within a periodicity. The operations of block 1705 may be performed in accordance with examples as disclosed herein. In some examples, aspects of the operations of 1705 may be performed by a discontinuous operation configuration component 1325 as described with reference to FIG. 13.

At 1710, the method may include allocating a set of symbols or slots for SSB transmission at the network entity for the cell-based DTX mode or for random access reception at the network entity for the cell-based DRX mode, where the set of symbols or slots at least partially overlaps with the inactive duration of the discontinuous operation mode. The operations of block 1710 may be performed in accordance with examples as disclosed herein. In some examples, aspects of the operations of 1710 may be performed by a periodic signaling component 1330 as described with reference to FIG. 13.

At 1715, the method may include extending the active duration of the discontinuous operation mode to overlap the set of symbols or slots based on at least one of the set of symbols or slots being within a threshold quantity of symbols or slots from the active duration prior to extension. The operations of block 1715 may be performed in accordance with examples as disclosed herein. In some examples, aspects of the operations of 1715 may be performed by an active duration extension component 1335 as described with reference to FIG. 13.

At 1720, the method may include participating in communications with a UE during the extended active duration through the SSB transmission or the random access reception. The operations of block 1720 may be performed in accordance with examples as disclosed herein. In some examples, aspects of the operations of 1720 may be performed by a periodic signaling component 1330 as described with reference to FIG. 13.

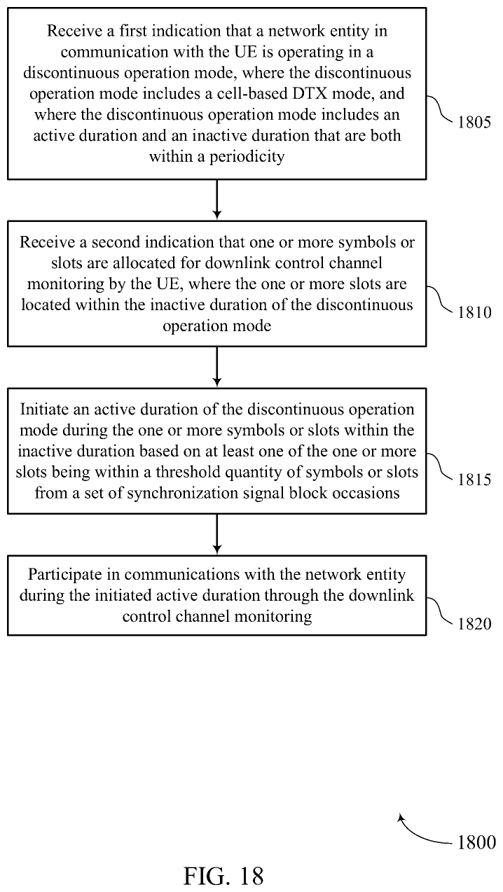

FIG. 18 shows a flowchart illustrating a method 1800 that supports extended active time of cellular DTX and DRX in accordance with aspects of the present disclosure. The operations of the method 1800 may be implemented by a UE or its components as described herein. For example, the operations of the method 1800 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1805, the method may include receive a first indication that a network entity in communication with the UE is operating in a discontinuous operation mode, where the discontinuous operation mode includes a cell-based DRX mode, and where the discontinuous operation mode includes an active duration and an inactive duration that are both within a periodicity. The operations of block 1805 may be performed in accordance with examples as disclosed herein. In some examples, aspects of the operations of 1805 may be performed by a discontinuous operation configuration component 925 as described with reference to FIG. 9.

At 1810, the method may include receive a second indication that one or more symbols or slots are allocated for downlink control channel monitoring by the UE, where the one or more symbols or slots are located within the inactive duration of the discontinuous operation mode. The operations of block 1810 may be performed in accordance with examples as disclosed herein. In some examples, aspects of the operations of 1810 may be performed by a discontinuous operation configuration component 925 as described with reference to FIG. 9.

At 1815, the method may include initiate an active duration of the discontinuous operation mode during the one or more symbols or slots within the inactive duration based on at least one of the one or more symbols or slots being within a threshold quantity of symbols or slots from a set of SSB occasions. The operations of block 1815 may be performed in accordance with examples as disclosed herein. In some examples, aspects of the operations of 1815 may be performed by an active duration initiation component 940 as described with reference to FIG. 9.

At 1820, the method may include participate in communications with the network entity during the initiated active duration through the downlink control channel monitoring. The operations of block 1820 may be performed in accordance with examples as disclosed herein. In some examples, aspects of the operations of 1820 may be performed by a periodic signaling component 930 as described with reference to FIG. 9.

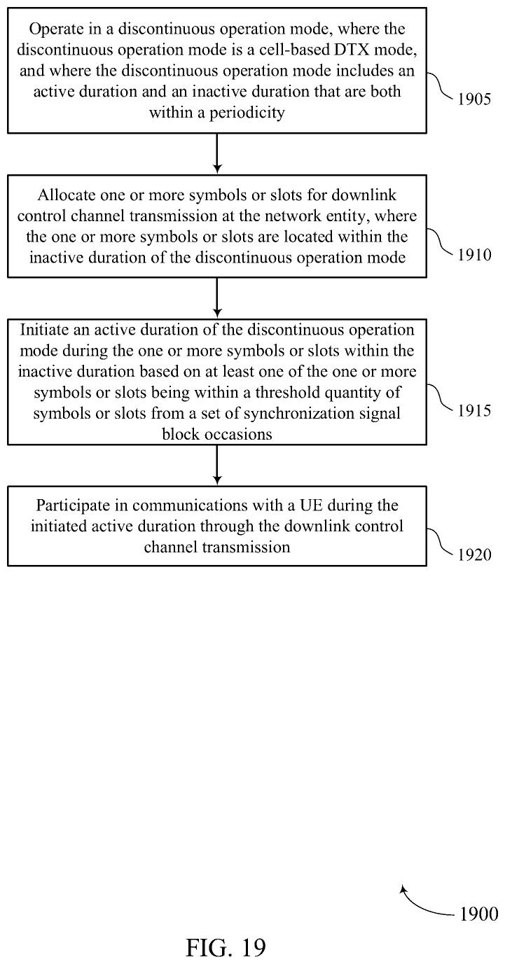

FIG. 19 shows a flowchart illustrating a method 1900 that supports extended active time of cellular DTX and DRX in accordance with aspects of the present disclosure. The operations of the method 1900 may be implemented by a network entity or its components as described herein. For example, the operations of the method 1900 may be performed by a network entity as described with reference to FIGS. 1 through 6 and 11 through 14. In some examples, a network entity may execute a set of instructions to control the functional elements of the network entity to perform the described functions. Additionally, or alternatively, the network entity may perform aspects of the described functions using special-purpose hardware.

At 1905, the method may include operating in a discontinuous operation mode, where the discontinuous operation mode is a cell-based DTX mode, and where the discontinuous operation mode includes an active duration and an inactive duration that are both within a periodicity. The operations of block 1905 may be performed in accordance with examples as disclosed herein. In some examples, aspects of the operations of 1905 may be performed by a discontinuous operation configuration component 1325 as described with reference to FIG. 13.

At 1910, the method may include allocating one or more symbols or slots for downlink control channel transmission at the network entity, where the set of symbols or slots are located within the inactive duration of the discontinuous operation mode.

The operations of block 1910 may be performed in accordance with examples as disclosed herein. In some examples, aspects of the operations of 1910 may be performed by a discontinuous operation configuration component 1325 as described with reference to FIG. 13.

At 1915, the method may include initiating an active duration of the discontinuous operation mode during the one or more symbols or slots within the inactive duration based on at least one of the set of symbols or slots being within a threshold quantity of symbols or slots from a set of SSB occasions. The operations of block 1915 may be performed in accordance with examples as disclosed herein. In some examples, aspects of the operations of 1915 may be performed by an active duration initiation component 1340 as described with reference to FIG. 13.

At 1920, the method may include participate in communications with a UE during the initiated active duration through the downlink control channel transmission. The operations of block 1920 may be performed in accordance with examples as disclosed herein. In some examples, aspects of the operations of 1920 may be performed by a periodic signaling component 1330 as described with reference to FIG. 13.

The following provides an overview of aspects of the present disclosure:

Aspect 1: A method for wireless communications at a UE, comprising: receiving a first indication that a network entity in communication with the UE is operating in a discontinuous operation mode, wherein the discontinuous operation mode is a cell-based DTX mode, a cell-based DRX mode, or both, and wherein the discontinuous operation mode includes an active period and an inactive period that are both within a periodicity; receiving a second indication that a set of symbols or slots is allocated for SSB reception at the UE for the cell-based DTX mode or for random access transmission at the UE for the cell-based DRX mode, wherein the set of symbols or slots at least partially overlap with the inactive period of the discontinuous operation mode; extending the active period of the discontinuous operation mode to overlap the set of symbols or slots based at least in part on at least one of the set of symbols or slots being within a threshold quantity of symbols or slots from the active period prior to extension; and participating in communications with the network entity during the extended active period through the SSB reception or the random access transmission.

Aspect 2: The method of aspect 1, wherein the threshold quantity of symbols or slots is a negative value so that extension of the active period is based at least in part on the set of symbols or slots partially overlapping with the active period prior to extension.

Aspect 3: The method of aspect 2, wherein the threshold quantity of symbols or slots is negative one.

Aspect 4: The method of any of aspects 1 through 3, wherein extending the active period of the discontinuous operation mode is further based on the set of symbols or slots being located before a start of the active period prior to extension.

Aspect 5: The method of any of aspects 1 through 4, wherein extending the active period of the discontinuous operation mode is further based on the set of symbols or slots being located after an end of the active period prior to extension.

Aspect 6: The method of any of aspects 1 through 5, wherein the threshold quantity of symbols or slots is a positive value so that extension of the active period is based at least in part on an edge slot or an edge symbol of the set of symbols or slots being less than the threshold quantity of symbols or slots from a boundary of the active period prior to extension.

Aspect 7: The method of aspect 6, wherein the edge slot or the edge symbol is a last symbol or slot of the set of symbols or slots, and the boundary is a beginning of the active period prior to extension.

Aspect 8: The method of aspect 7, wherein extending the active period of the discontinuous operation further comprises: shifting the beginning of the active period to begin at a first symbol or slot of the set of symbols or slots.

Aspect 9: The method of any of aspects 6 through 8, wherein the edge symbol or edge slot is a first symbol or a first slot of the set of symbols or slots, and the boundary is an ending of the active period prior to extension.

Aspect 10: The method of aspect 9, wherein extending the active period of the discontinuous operation mode further comprises: shifting the ending of the active period to end at a last symbol or a last symbol or slot of the set of symbols or slots.

Aspect 11: The method of any of aspects 1 through 10, wherein the threshold quantity of symbols or slots comprises a fixed value, is received via radio resource control signaling, is based at least in part on a capability of the UE, or combinations thereof.

Aspect 12: The method of any of aspects 1 through 11, wherein the threshold quantity of symbols or slots is a first value when extension of the active period includes a shifting of a beginning of the active period and a second value when extension of the active period includes a shifting of an ending of the active period, and the first value and the second value are a same value.

Aspect 13: The method of any of aspects 1 through 12, wherein the threshold quantity of symbols or slots is a first value when extension of the active period includes a shifting of a beginning of the active period and a second value when extension of the active period includes a shifting of an ending of the active period, and the first value and the second value are different values.

Aspect 14: The method of any of aspects 1 through 13, wherein the instructions to receive the second indication are further executable by the processor to cause the method to receive the second indication in a system information block, wherein the second indication indicates one or more locations for the SSB reception or the random access transmission at the UE.

Aspect 15: The method of aspect 14, wherein the second indication further indicates the one or more locations as being associated with a set of transmitted SSBs from a set of SSBs in a SSB transmission occasion.

Aspect 16: The method of any of aspects 14 through 15, further comprising: determining the one or more locations for the SSB reception based at least in part on a total number of SSBs that are scheduled to be transmitted in a SSB transmission occasion.

Aspect 17: The method of any of aspects 1 through 16, further comprising: transmitting a capability indication message indicating a capability of the UE to support extension of the active period for the SSB reception or for the random access transmission at the UE.

Aspect 18: The method of any of aspects 1 through 17, wherein the set of symbols or slots is allocated for both the SSB reception and for the random access transmission at the UE, the method further comprising: determining to extend the active period of the discontinuous operation mode based at least in part on one of the SSB reception or the random access transmission.

Aspect 19: The method of any of aspects 1 through 18, wherein the set of symbols or slots is allocated for both the SSB reception and for the random access transmission at the UE, the method further comprising: determining to extend the active period of the discontinuous operation mode based at least in part on both the SSB reception and the random access transmission.

Aspect 20: The method of any of aspects 1 through 19, wherein the second indication comprises one or more separate configurations or a joint configuration for the SSB reception and for the random access transmission at the UE.

Aspect 21: An method for wireless communications at a network entity, comprising: operating in a discontinuous operation mode, wherein the discontinuous operation mode is a cell-based DTX mode, a cell-based DRX mode, or both, and wherein the discontinuous operation mode includes an active period and an inactive period that are both within a periodicity; allocating a set of symbols or slots for SSB transmission at the network entity for the cell-based DTX mode or for random access reception at the network entity for the cell-based DRX mode, wherein the set of symbols or slots at least partially overlaps with the inactive period of the discontinuous operation mode; extending the active period of the discontinuous operation mode to overlap the set of symbols or slots based at least in part on at least one of the set of symbols or slots being within a threshold quantity of symbols or slots from the active period prior to extension; and participating in communications with a UE during the extended active period through the SSB transmission or the random access reception.

Aspect 22: The method of aspect 21, wherein the threshold quantity of symbols or slots is a negative value so that extension of the active period is based at least in part on the set of symbols or slots partially overlapping with the active period prior to extension.

Aspect 23: The method of aspect 22, wherein the threshold quantity of symbols or slots is negative one.

Aspect 24: The method of any of aspects 21 through 23, wherein extending the active period of the discontinuous operation mode is further based on the set of symbols or slots being located before a start of the active period or before an end of the active period prior to extension.

Aspect 25: The method of any of aspects 21 through 24, wherein extending the active period of the discontinuous operation mode is further based on the set of symbols or slots being located after an end of the active period prior to extension.

Aspect 26: The method of any of aspects 21 through 25, wherein the threshold quantity of symbols or slots is a positive value so that extension of the active period is based at least in part on an edge symbol or slot of the set of symbols or slots being less than the threshold quantity of slots from a boundary of the active period prior to extension.

Aspect 27: The method of aspect 26, wherein the edge symbol or slot is a last symbol or slot of the set of symbols or slots, and the boundary is a beginning of the active period prior to extension.

Aspect 28: The method of aspect 27, wherein extending the active period of the discontinuous operation further comprises: shifting the beginning of the active period to begin at a first symbol or slot of the set of symbols or slots.

Aspect 29: The method of any of aspects 26 through 28, wherein the edge symbol or slot is a first symbol or slot of the set of symbols or slots, and the boundary is an ending of the active period prior to extension.

Aspect 30: The method of aspect 29, wherein extending the active period of the discontinuous operation mode further comprises: shifting the ending of the active period to end at a last symbol or slot of the set of symbols or slots.

Aspect 31: The method of any of aspects 21 through 30, wherein the threshold quantity of symbol or slots comprises a fixed value, is transmitted via radio resource control signaling, is based at least in part on a capability of the UE, or combinations thereof.

Aspect 32: The method of any of aspects 21 through 31, wherein the threshold quantity of symbols or slots is a first value when extension of the active period includes a shifting of a beginning of the active period and a second value when extension of the active period includes a shifting of an ending of the active period, the first value and the second value are a same value.

Aspect 33: The method of any of aspects 21 through 32, wherein the threshold quantity of symbols or slots is a first value when extension of the active period includes a shifting of a beginning of the active period and a second value when extension of the active period includes a shifting of an ending of the active period, the first value and the second value are different values.

Aspect 34: The method of any of aspects 21 through 33, further comprising: receiving a capability indication message indicating a capability of the UE to support extension of the active period.

Aspect 35: The method of any of aspects 21 through 34, wherein the set of symbols or slots is allocated for both the SSB transmission and for the random access reception at the UE, the method further comprising: extending the active period of the discontinuous operation mode based at least in part on one of the SSB transmission or the random access reception.

Aspect 36: The method of any of aspects 21 through 35, wherein the set of symbols or slots is allocated for both the SSB transmission and for the random access reception at the UE, the method further comprising: extending the active period of the discontinuous operation mode based at least in part on both the SSB transmission and the random access reception.

Aspect 37: The method of any of aspects 21 through 36, wherein the set of symbols or slots are allocated via one or more separate configurations or a joint configuration for the SSB transmission and for the random access reception.

Aspect 38: An method for wireless communications at a UE, comprising: receiving a first indication that a network entity in communication with the UE is operating in a discontinuous operation mode, wherein the discontinuous operation mode comprises a cell-based DTX mode, and wherein the discontinuous operation mode includes an active period and an inactive period that are both within a periodicity; receiving a second indication that one or more symbols or slots are allocated for downlink control channel monitoring by the UE, wherein the one or more symbols or slots are located within the inactive period of the discontinuous operation mode; initiating an active period of the discontinuous operation mode during the one or more symbols or slots within the inactive period based at least in part on at least one of the one or more symbols or slots being within a threshold quantity of symbols or slots from a set of SSB occasions; and participating in communications with the network entity during the initiated active period through the downlink control channel monitoring.

Aspect 39: The method of aspect 38, wherein the threshold quantity of symbols or slots is a negative value so that the initiated active period is based at least in part on the one or more symbols or slots partially overlapping with the set of SSB occasions.

Aspect 40: The method of aspect 39, wherein the threshold quantity of symbols or slots is negative one.

Aspect 41: The method of any of aspects 38 through 40, wherein the one or more symbols or slots are included within the initiated active period within the inactive period based at least in part on a periodicity of the set of SSB occasions, a configuration of the cell-based DTX mode, a periodicity of the cell-based DTX mode, the threshold quantity of symbols or slots being overlapping with a set of downlink control channel monitoring occasions, or any combination thereof.

Aspect 42: The method of any of aspects 38 through 41, wherein the initiated active period is further based on the one or more symbols or slots being located before a beginning of a scheduled active period of the cell-based DTX mode or after an end of the active period of the cell-based DTX mode.

Aspect 43: The method of any of aspects 38 through 42, wherein the threshold quantity of symbols or slots is a positive value so that the initiated active period is based at least in part on an edge symbol or slot of the one or more symbols or slots being less than the threshold quantity of symbols or slots from a boundary of the set of SSB occasions.

Aspect 44: The method of any of aspects 38 through 43, wherein the downlink control channel monitoring comprises one or more downlink control channel occasions located in a UE-specific search space or a common search space set.

Aspect 45: The method of any of aspects 38 through 44, wherein the initiated active period occurs within the inactive period.

Aspect 46: An method for wireless communications at a network entity, comprising: operating in a discontinuous operation mode, wherein the discontinuous operation mode is a cell-based DTX mode, and wherein the discontinuous operation mode includes an active period and an inactive period that are both within a periodicity; allocating one or more symbols or slots for downlink control channel transmission at the network entity, wherein the one or more symbols or slots are located within the inactive period of the discontinuous operation mode; initiating an active period of the discontinuous operation mode during the one or more symbols or slots within the inactive period based at least in part on at least one of the one or more symbols or slots being within a threshold quantity of symbols or slots from a set of SSB occasions; and participating in communications with a UE during the initiated active period through the downlink control channel transmission.

Aspect 47: The method of aspect 46, wherein the threshold quantity of symbols or slots is a negative value so that the initiated active period is based at least in part on the one or more symbols or slots partially overlapping with the set of SSB occasions.

Aspect 48: The method of aspect 47, wherein the threshold quantity of symbols or slots is negative one.

Aspect 49: The method of any of aspects 46 through 48, wherein the one or more symbols or slots are included within the initiated active period within the inactive period based at least in part on a periodicity of the set of SSB occasions, a configuration of the cell-based DTX mode, a periodicity of the cell-based DTX mode, the threshold quantity of symbols or slots being overlapping with a set of downlink control channel monitoring occasions, or any combination thereof.

Aspect 50: The method of any of aspects 46 through 49, wherein the initiated active period is further based on the one or more symbols or slots being located before a beginning of a scheduled active period of the cell-based DTX mode or after an end of the active period of the cell-based DTX mode.

Aspect 51: The method of any of aspects 46 through 50, wherein the threshold quantity of symbols or slots is a positive value so that the initiated active period is based at least in part on an edge symbol or slot of the one or more symbols or slots being less than the threshold quantity of symbols or slots from a boundary of the set of SSB occasions.

Aspect 52: The method of any of aspects 46 through 51, wherein the downlink control channel transmission comprises one or more downlink control channel occasions located in a UE-specific search space or a common search space set.

Aspect 53: The method of any of aspects 46 through 52, wherein the initiated active period occurs within the inactive period.

Aspect 54: An apparatus for wireless communications at a UE, comprising a processor; memory coupled with the processor; and instructions stored in the memory and executable by the processor to cause the apparatus to perform a method of any of aspects 1 through 20.

Aspect 55: An apparatus for wireless communications at a UE, comprising at least one means for performing a method of any of aspects 1 through 20.

Aspect 56: A non-transitory computer-readable medium storing code for wireless communications at a UE, the code comprising instructions executable by a processor to perform a method of any of aspects 1 through 20.

Aspect 57: An apparatus for wireless communications at a network entity, comprising a processor; memory coupled with the processor; and instructions stored in the memory and executable by the processor to cause the apparatus to perform a method of any of aspects 21 through 37.

Aspect 58: An apparatus for wireless communications at a network entity, comprising at least one means for performing a method of any of aspects 21 through 37.

Aspect 59: A non-transitory computer-readable medium storing code for wireless communications at a network entity, the code comprising instructions executable by a processor to perform a method of any of aspects 21 through 37.

Aspect 60: An apparatus for wireless communications at a UE, comprising a processor; memory coupled with the processor; and instructions stored in the memory and executable by the processor to cause the apparatus to perform a method of any of aspects 38 through 45.

Aspect 61: An apparatus for wireless communications at a UE, comprising at least one means for performing a method of any of aspects 38 through 45.

Aspect 62: A non-transitory computer-readable medium storing code for wireless communications at a UE, the code comprising instructions executable by a processor to perform a method of any of aspects 38 through 45.

Aspect 63: An apparatus for wireless communications at a network entity, comprising a processor; memory coupled with the processor; and instructions stored in the memory and executable by the processor to cause the apparatus to perform a method of any of aspects 46 through 53.

Aspect 64: An apparatus for wireless communications at a network entity, comprising at least one means for performing a method of any of aspects 46 through 53.

Aspect 65: A non-transitory computer-readable medium storing code for wireless communications at a network entity, the code comprising instructions executable by a processor to perform a method of any of aspects 46 through 53.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. An apparatus for wireless communications at a user equipment (UE), comprising:
a processor;
memory coupled with the processor; and
instructions stored in the memory and executable by the processor to cause the apparatus to:
receive a first indication that a network entity in communication with the UE is operating in a discontinuous operation mode, wherein the discontinuous operation mode is a cell-based discontinuous transmission mode, a cell-based discontinuous reception mode, or both, and wherein the discontinuous operation mode includes an active period and an inactive period that are both within a periodicity;
receive a second indication that a set of symbols or slots is allocated for synchronization signal block reception at the UE for the cell-based discontinuous transmission mode or for random access transmission at the UE for the cell-based discontinuous reception mode, wherein the set of symbols or slots at least partially overlap with the inactive period of the discontinuous operation mode;
extend the active period of the discontinuous operation mode to overlap the set of symbols or slots based at least in part on at least one of the set of symbols or slots being within a threshold quantity of symbols or slots from the active period prior to extension; and
participate in communications with the network entity during the extended active period through the synchronization signal block reception or the random access transmission.

2. The apparatus of claim 1, wherein the threshold quantity of symbols or slots is a negative value so that extension of the active period is based at least in part on the set of symbols or slots partially overlapping with the active period prior to extension.

3. The apparatus of claim 2, wherein:
the threshold quantity of symbols or slots is negative one.

4. The apparatus of claim 1, wherein extending the active period of the discontinuous operation mode is further based on the set of symbols or slots being located before a start of the active period prior to extension.

5. The apparatus of claim 1, wherein extending the active period of the discontinuous operation mode is further based on the set of symbols or slots being located after an end of the active period prior to extension.

6. The apparatus of claim 1, wherein the threshold quantity of symbols or slots is a positive value so that extension of the active period is based at least in part on an edge slot or an edge symbol of the set of symbols or slots being less than the threshold quantity of symbols or slots from a boundary of the active period prior to extension.

7. The apparatus of claim 6, wherein the edge slot or the edge symbol is a last symbol or slot of the set of symbols or slots, and the boundary is a beginning of the active period prior to extension.

8. The apparatus of claim 7, wherein the instructions to extend the active period of the discontinuous operation mode are executable by the processor to cause the apparatus to:
shift the beginning of the active period to begin at a first symbol or slot of the set of symbols or slots.

9. The apparatus of claim 6, wherein the edge symbol or edge slot is a first symbol or a first slot of the set of symbols or slots, and the boundary is an ending of the active period prior to extension.

10. The apparatus of claim 9, wherein the instructions to extend the active period of the discontinuous operation mode are executable by the processor to cause the apparatus to:
shift the ending of the active period to end at a last symbol or a last symbol or slot of the set of symbols or slots.

11. The apparatus of claim 1, wherein the threshold quantity of symbols or slots comprises a fixed value, is received via radio resource control signaling, is based at least in part on a capability of the UE, or combinations thereof.

12. The apparatus of claim 1, wherein the threshold quantity of symbols or slots is a first value when extension of the active period includes a shifting of a beginning of the active period and a second value when extension of the active period includes a shifting of an ending of the active period, and the first value and the second value are a same value.

13. The apparatus of claim 1, wherein the threshold quantity of symbols or slots is a first value when extension of the active period includes a shifting of a beginning of the active period and a second value when extension of the active period includes a shifting of an ending of the active period, and the first value and the second value are different values.

14. The apparatus of claim 1, wherein the instructions to receive the second indication are further executable by the processor to cause the apparatus to:
receive the second indication in a system information block, wherein the second indication indicates one or more locations for the synchronization signal block reception or the random access transmission at the UE.

15. The apparatus of claim 14, wherein the second indication further indicates the one or more locations as being associated with a set of transmitted synchronization signal blocks from a set of synchronization signal blocks in a synchronization signal block transmission occasion.

16. The apparatus of claim 14, wherein the instructions are further executable by the processor to cause the apparatus to:
determine the one or more locations for the synchronization signal block reception based at least in part on a total number of synchronization signal blocks that are scheduled to be transmitted in a synchronization signal block transmission occasion.

17. The apparatus of claim 1, wherein the instructions are further executable by the processor to cause the apparatus to:
transmit a capability indication message indicating a capability of the UE to support extension of the active period for the synchronization signal block reception or for the random access transmission at the UE.

18. The apparatus of claim 1, wherein the set of symbols or slots is allocated for both the synchronization signal block reception and for the random access transmission at the UE, and the instructions are further executable by the processor to cause the apparatus to:
determine to extend the active period of the discontinuous operation mode based at least in part on one of the synchronization signal block reception or the random access transmission.

19-20. (canceled)

21. An apparatus for wireless communications at a network entity, comprising:
a processor;
memory coupled with the processor; and
instructions stored in the memory and executable by the processor to cause the apparatus to:
operate in a discontinuous operation mode, wherein the discontinuous operation mode is a cell-based discontinuous transmission mode, a cell-based discontinuous reception mode, or both, and wherein the discontinuous operation mode includes an active period and an inactive period that are both within a periodicity;
allocate a set of symbols or slots for synchronization signal block transmission at the network entity for the cell-based discontinuous transmission mode or for random access reception at the network entity for the cell-based discontinuous reception mode, wherein the set of symbols or slots at least partially overlaps with the inactive period of the discontinuous operation mode;
extend the active period of the discontinuous operation mode to overlap the set of symbols or slots based at least in part on at least one of the set of symbols or slots being within a threshold quantity of symbols or slots from the active period prior to extension; and
participate in communications with a user equipment (UE) during the extended active period through the synchronization signal block transmission or the random access reception.

22-37. (canceled)

38. An apparatus for wireless communications at a user equipment (UE), comprising:
a processor;
memory coupled with the processor; and
instructions stored in the memory and executable by the processor to cause the apparatus to:
receive a first indication that a network entity in communication with the UE is operating in a discontinuous operation mode, wherein the discontinuous operation mode comprises a cell-based discontinuous transmission mode, and wherein the discontinuous operation mode includes an active period and an inactive period that are both within a periodicity;
receive a second indication that one or more symbols or slots are allocated for downlink control channel monitoring by the UE, wherein the one or more symbols or slots are located within the inactive period of the discontinuous operation mode;
initiate an active period of the discontinuous operation mode during the one or more symbols or slots within the inactive period based at least in part on at least one of the one or more symbols or slots being within a threshold quantity of symbols or slots from a set of synchronization signal block occasions; and
participate in communications with the network entity during the initiated active period through the downlink control channel monitoring.

39-57. (canceled)
